(19) United States
(12) Patent Application Publication
(10) Pub. No.: US 2026/0079096 A1
(43) Pub. Date: Mar. 19, 2026

(54) METHODS AND APPARATUS OF IMAGE CAPTURE AND AUTOMATED REGULATION FOR DROPLET FORMATION AND DEFLECTION CONTROL IN CELL SORTERS

(71) Applicant: Cytek Biosciences, Inc., Fremont, CA (US)

(72) Inventor: Mohammad N Saadatzi, Fremont, CA (US)

(73) Assignee: Cytek Biosciences, Inc., Fremont, CA (US)

(21) Appl. No.: 19/334,710

(22) Filed: Sep. 19, 2025

Related U.S. Application Data
(60) Provisional application No. 63/696,382, filed on Sep. 19, 2024.

(51) Int. Cl. G01N 15/1434; G01N 15/01; G01N 15/10; G01N 15/1404; G01N 15/149

(52) U.S. Cl. CPC G01N 15/1436; G01N 15/01; G01N 15/1404; G01N 2015/1006; G01N 15/149

(57) ABSTRACT

In one embodiment, a system includes a flow cell with a conductive electrode and a base having an opening allowing variable charged sheathed sample fluid to flow out along a fluid axis, a droplet deflection unit with a pair of charge plates and a deflection chamber with a pivot door closing over the chamber a hardware triggered camera mounted to the back of the deflection chamber, and an LED array strobe light mounted to the pivotal door opposite the camera. The LED array strobe light generates a backlighting for various droplet streams. Triggering of the camera is synchronized with the generation of the backlighting to periodically capture a brightfield still image of deflected droplets and center droplets in the deflection chamber. The captured images can be analyzed for droplet deflection angles and center line for visual feedback control of the deflected droplets and the center droplets in respective droplet streams.

### CROSS-REFERENCE TO RELATED APPLICATIONS

This patent application is a non-provisional claiming priority to U.S. (U.S.) Provisional Patent Application No. 63/696,382 titled METHODS AND APPARATUS OF IMAGE CAPTURE AND AUTOMATED REGULATION FOR DROPLET DEFLECTION CONTROL IN CELL SORTERS filed on Sep. 19, 2024, by inventor Mohammad N. Saadatzi.

This patent application incorporates by reference U.S. (U.S.) patent application Ser. No. 17/665,480 titled INTEGRATED COMPACT CELL SORTER filed on Feb. 4, 2022, by inventors Glen Krueger et al., for all intents and purposes. This patent application further incorporates by reference U.S. (U.S.) patent application Ser. No. 18/797,275 titled IMAGE CAPTURE AND AUTOMATED REGULATION FOR LIQUID JET BREAKOFF IN CELL SORTERS filed on Aug. 7, 2024, by inventor Mohammad N. Saadatzi, for all intents and purposes. The terminology of this application is controlling over that used in application Ser. Nos. 18/797,275 and 17/665,480 should there be any conflicts.

### FIELD

The embodiments of the invention relate generally to the control of droplet formation and deflection in cell sorter systems.

### BACKGROUND

Flow cytometry and cell sorting involves the optical measurement of biological cells or particles of a test sample carried in a fluid flow. While a flow cytometer detects information about biological cells and particles, a cell sorter (sorting flow cytometer) further sorts out selected cells of interest into different containers (e.g., test tubes) for further usage (e.g., testing) or counting. A cell sorter can also be referred to as a sorting flow cytometer.

A cell sorter selectively charges droplets of flowing biological sells encapsulated by a sheath fluid either with a positive or a negative charge that are desired to be sorted out from a waste stream. The charged droplets with biological cells are deflected off of a center stream into one of one or more left streams or one or more right streams by an electrostatic field. If a biological cell is to be discarded, the droplet is not charged. With an uncharged droplet, the electrostatic field does not deflect the droplet so that it remains in the center stream to fall into a waste bucket.

To properly charge and sort droplets, the breakoff of droplets from a jet stream and the droplet formation process is a key aspect. Until a droplet breaks off from the jet stream, it can be charged. Accordingly, the better controlled the droplet formation, the better is the selective sorting of droplets. Furthermore, if the charge applied to droplets is better controlled, the selective sorting of droplets can generally be improved. That is, it is desirable to improve charge application to droplets during droplet formation prior to jet breakoff in order to improve the sorting process over prior cell sorting flow cytometer systems.

### SUMMARY

The embodiments are best summarized by the claims. Briefly, in some aspects, the techniques described herein relate to a droplet deflection unit (DDU) for a cell sorter, the droplet deflection unit including: a case including a back portion with a deflection chamber and an upper opening to receive a plurality of droplets of a droplet stream along a center fluid axis and a base slot to allow deflected droplets to fall into one or more containers; a pair of spaced apart charge plates mounted in the case above the deflection chamber through which to receive the plurality of droplets along the center fluid axis, the pair of spaced apart charge plates charged to opposite voltages to deflect one or more charged droplets of the plurality of droplets away from the center fluid axis along one or more desired deflection axes to fall into the one or more containers while other droplets of the plurality of droplets continue falling along the center fluid axis; a pivotal door pivotally coupled to the back portion of the case to cover over the deflection chamber; a first hardware triggered camera mounted to the back portion of the deflection chamber behind a window, the first hardware triggered camera having a field of view to capture images of the one or more deflected droplets and droplets along the center fluid axis after passing through the pair of charge plates; and a light emitting diode (LED) array strobe light mounted into an opening in the pivotal door on an opposite side of the first hardware triggered camera, the LED strobe array light pointed into the deflection chamber; wherein an activation of the LED array strobe light generates a strobe light into the deflection chamber to backlight the droplet stream in synchronous with a triggering of the hardware triggered camera to periodically capture a brightfield still image of a portion of the droplet stream along various fluid axes below the pair of charge plates including the center fluid axis and the one or more desired deflection axes.

In some aspects, the techniques described herein relate to an apparatus including: controller for, the controller including: a cell sorter system including a nozzle to form a plurality of droplets in a droplet stream and a pair of spaced apart charge plates mounted in a case below the nozzle, wherein the pair of spaced apart charge plates are charged to opposite voltages to deflect one or more charged droplets of the plurality of droplets in the droplet stream away from a center fluid axis along one or more desired deflection axes; a jet break off controller coupled to the cell sorter system, the jet break off controller to control a position of jet break off of droplets after the nozzle, the jet break off controller having image feedback to control positional error in the desired position of jet break off; and a droplet deflection controller coupled to the cell sorter system, the droplet deflection controller to control one or more angles of deflected droplets along desired deflection axes, the droplet deflection controller having image feedback to control angular error of deflected droplets off of the center fluid axis to the one or more desired deflection axes.

In some aspects, the techniques described herein relate to a flow cytometer or cell sorter system, the system including: a fluidics system under pressure to cause a sheath fluid and a sample fluid with cells or particles to flow; a flow cell assembly coupled in communication with the fluidics system to receive the sheath fluid and the sample fluid, the flow cell assembly including a flow cell body to surround the sample fluid with the sheath fluid to form a sheathed sample fluid, wherein the flow cell body has a base with a circular opening to allow a stream of the sheathed sample fluid to flow out and subsequently form a droplet stream along a fluid axis, the flow cell assembly further including a conductive electrode to receive and impart a variable electrical charge on the stream of the sheathed sample fluid to vary the electrical charge to the droplets in the droplet stream along the fluid axis; a droplet deflection unit (DDU) to receive the droplet along the fluid axis, the droplet deflection unit including a back portion with a deflection chamber and a pivotal door pivotally coupled to the back portion to cover over the deflection chamber, the deflection chamber including a pair of charge plates through which the droplet stream falls along the fluid axis; a first hardware triggered camera mounted to the back portion of the deflection chamber, the hardware triggered camera having a field of view to capture images of deflected droplets and centered droplets of the droplet stream along various fluid axes after passing through the pair of charge plates; and a light emitting diode (LED) array strobe light mounted to the pivotal door on an opposite side of the first hardware triggered camera, the LED strobe array light pointed into the deflection chamber; wherein an activation of the LED array strobe light generating a strobe light into the deflection chamber backlighting the droplet stream is synchronized with a triggering of the first hardware triggered camera to periodically capture a brightfield still image of a portion of the droplet stream along the various fluid axes below the pair of charge plates.

In some aspects, the techniques described herein relate to a method for a cell sorter system, the method including: capturing a raw brightfield still image of at least one deflected droplet and a center droplet stream along a fluid axis with a backlighting provided by a synchronized strobe lighting; image processing the raw brightfield still image to provide a noiseless binary image of the at least one deflected droplet and the center droplet stream; identifying single droplets from merged droplets and identifying deflected single deflected droplets in the noiseless binary image of the at least one deflected droplet and the center droplet stream; extracting morphological features of the single droplets in the noiseless binary image of the center droplet stream; determining a measured deflection angle for each deflected droplet in the noiseless binary image of the at least one deflected droplet and the center droplet stream; and clustering similar deflected droplets together in the noiseless binary image of the at least one deflected droplet and the center droplet stream based on the measured deflection angle for each deflected droplet.

In some aspects, the techniques described herein relate to a method for a flow cytometer or a cell sorter system, the method including: capturing a raw brightfield still image of a droplet stream along a fluid axis with a diffused infrared backlighting provided by a synchronized diffused strobe lighting; image processing the raw brightfield still image to provide a noiseless binary image of the droplet stream; determining a measured jet breakoff point in the noiseless binary image of the droplet stream; comparing the measure jet breakoff point with a desired jet breakoff point to determine a jet breakoff error; and based on the jet breakoff error, adjusting an amplitude in an alternating current (AC) waveform signal that drives a piezo-electric device to vibrate and cause a sample fluid to form one or more droplets in the droplet stream.

In some aspects, the techniques described herein relate to a droplet control system for a flow cytometer or cell sorter, the droplet control system including: a waveform synthesizer to generate an alternating current (AC) waveform signal at a selected frequency; a variable gain amplifier coupled to the waveform synthesizer, the variable gain amplifier modifying an amplitude of the AC waveform signal based on a gain signal to form a variable gain AC waveform signal; a high voltage amplifier coupled to the variable gain amplifier to receive the variable gain AC waveform signal, the high voltage amplifier having a constant gain to increase the amplitude of the variable gain AC waveform signal into a high voltage AC waveform signal; a piezo-electric device coupled to the high voltage amplifier to receive the high voltage AC waveform signal and vibrate a sheathed sample fluid to form one or more droplets in a droplet stream; a diffused light emitting diode (LED) strobe light to periodically generate a diffused infrared backlighting for the droplet stream synchronized with the AC waveform signal; a first hardware triggered camera to periodically capture a brightfield still image of the droplet stream in synchronous with periodic generation of the diffused infrared backlighting by the diffused LED strobe light; an LED array strobe light to periodically generate a backlighting, synchronized with the AC waveform signal, for a center droplet stream and one or more deflected droplets along one or more deflection axes; a second hardware triggered camera to periodically capture a brightfield still image of the center droplet stream and one or more deflected droplets along one or more deflection axes with periodic generation of the backlighting by the LED array strobe light; a first image processor coupled in communication with the variable gain amplifier and the hardware triggered camera, the first image processor to receive the brightfield still image of the droplet stream from the first hardware triggered camera, the first image processor further receiving a selected jet breakoff point and a selected droplet interval, the first image processor to process the brightfield still image of the droplet stream to determine a measured jet breakoff point and compare the measured jet breakoff point with the selected jet breakoff point to determine a jet breakoff error and generate the gain signal to vary the amplitude of the variable gain AC waveform signal to correct for the jet breakoff error; and a second image processor coupled in communication with the variable gain amplifier and the second hardware triggered camera, the second image processor to receive the brightfield still image of the deflected droplet stream from the second hardware triggered camera, the second image processor to process the brightfield still image of the deflected droplet stream to determine a deflection error in one or more deflection droplets off of one or more deflection axes and generate an offset voltage signal to vary the charges applied to droplets being deflected to correct for deflection error.

In some aspects, the techniques described herein relate to an apparatus for controlling droplet deflection in a cell sorter, the apparatus including: a storage device to store instructions for execution; a processor coupled to the storage device to execute the instructions stored in the storage device, and a display device coupled in communication with the processor, the display device to display a graphical user interface (GUI) generated by the processor executing instructions including a droplet deflection control GUI, the display device displaying the droplet deflection control GUI including: a plurality of droplet deflection image windows; and one or more control input windows below the plurality of droplet deflection image windows, wherein at least one of the one or more control input windows is a sort voltage control input window to set a plurality of center sort voltages for a respective plurality of desired deflection axes.

### BRIEF DESCRIPTIONS OF THE DRAWINGS

Various embodiments are illustrated by way of example, and not by way of limitation, in the Figures of the accompanying drawings.

FIG. 1 is a basic conceptual diagram of a cell sorter system (a sorting flow cytometer system), and a flow cytometer system is shown.

FIG. 2A is a front perspective view of components in a flow cell of a cell sorter/flow cytometer system.

FIG. 2B is an exploded view of components in the flow cell assembly in the compact cell sorter system that can be used to adjust the formation of droplets in the sample stream.

FIG. 2C is a cross sectional assembled view of portions of the flow cell assembly including a drop drive assembly.

FIG. 3A is a front view of the deflection unit, with cover removed, in the compact cell sorter system illustrating three possible droplet stream axes.

FIG. 3B is an exploded view of an upgraded drop deflection chamber, with an open front light door and backside camera.

FIG. 3C is an assembled view of the upgraded drop deflection chamber, with the open front light door and backside camera shown in FIG. 3B.

FIG. 3D is an assembled view of the upgraded drop deflection chamber with the front light door in a closed position.

FIG. 3E is a perspective view of the front LED light array for the door of the drop deflection chamber.

FIG. 4A illustrates a schematic diagram of a side view of the fluid axis of the stream of drops in relation to the optical axes of the sort camera and the front strobe light source provided by the LED light array.

FIG. 4B illustrates a schematic diagram of a top view of the fluid axis of the stream of drops in relation to the optical axes of the jet break off camera and the diffused strobe light source with respect to the flat mirror.

FIG. 4C is a schematic view of LED strobe lights with a diffuser to form a diffused strobe light and the generated backlighting associated therewith.

FIG. 5 illustrates a front view of a plurality of potential fluid axes of the stream of deflected droplets about a center stream of droplets.

FIG. 6A-6D are schematic views of various droplet deflection that can occur.

FIGS. 7A-7D illustrate image processing of a raw deflected droplet image with a center stream of droplets and deflected droplets.

FIG. 8 illustrates various computer vision and machine learning stages of a raw droplet deflection image that captures a stream of center stream of droplets and deflected droplets.

FIG. 9 is a magnified image of a droplet for morphological feature extraction and analysis.

FIG. 10 (FIGS. 10A-10B) is a functional block diagram of a droplet control system for jet breakoff control and droplet deflection.

FIG. 11A illustrates an exposure time window for a conventional software triggered camera and a conventional LED strobe light.

FIG. 11B illustrates an exposure time window for hardware triggered cameras and LED strobe lights for capturing images for droplet jet breakoff and droplet deflection.

FIGS. 12A-12C are views of droplet position charts over three points in time for a charged drop moved off a center axis of drops.

FIG. 13 illustrates a graphical user interface (GUI) window executed by a processor and displayed on a display device for droplet deflection control.

It will be recognized that some or all of the Figures are for purposes of illustration and do not necessarily depict the actual relative sizes or locations of the elements shown. The Figures are provided for the purpose of illustrating one or more embodiments with the explicit understanding that they will not be used to limit the scope or the meaning of the claims.

### DETAILED DESCRIPTION

In the following detailed description of the embodiments, numerous specific details are set forth. However, it will be obvious to one skilled in the art that the embodiments may be practiced without these specific details. In other instances, well-known methods, procedures, components, and circuits have not been described in detail so as not to unnecessarily obscure aspects of the embodiments. The various sections of this description are provided for organizational purposes. However, many details and advantages apply across multiple sections.

Generally, a droplet stream can include a jet stream, one or more droplets, and, potentially, one or more satellites along the same fluid axis. A droplet generally includes a biological cell or some other sort of particle (e.g., a bead) or particles. Droplet formation (also referred to as capillary jet breakup) somewhat takes place due to competing gravity and surface tension forces. When the gravity force exceeds the attaching surface tension force, a liquid is pulled in the form of a long thread, that can further lead to necking and breakup resulting in the formation of a droplet. Gravitational force is significant in case of large droplets and less significant for satellites. Satellites are formed by the breakup of the ligament that connects two droplets, or one droplet to the jet stream.

Methods and apparatus of image capture and automated regulation of deflection angle in electrostatically charged droplets in an electric field are disclosed. Raw brightfield still images deflected droplets along deflection axes and center droplets along a center fluid axis can be captured by a high speed hardware triggered camera with synchronized strobe lighting providing the backlight for each image. Imaging and image processing techniques for high-velocity droplet train within an electric field are disclosed that allow for spatial localization of droplets in a two dimensional (2-D) plane parallel to the electric field and the droplet train itself of deflected droplets and center droplets. From the images, machine learning algorithms are used to clustered together similar deflected droplets into clusters such as center droplets and one or more clusters of deflected droplets on different deflection axes. Such spatial determination of droplets along with signal processing and control techniques enable timely charging of the droplet train, in a droplet-by-droplet fashion, which, in turn, can provide for real-time and accurate regulation of deflection angle in target droplets.

### System Overview

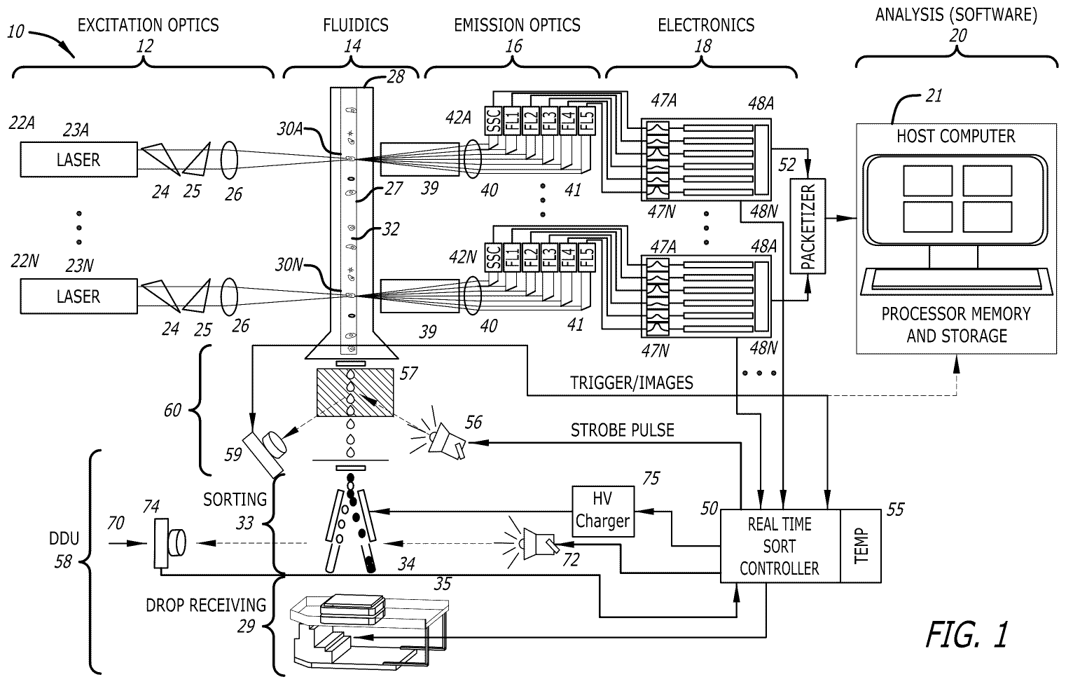

FIG. 1 is a basic conceptual diagram of a cell sorter system (sorting flow cytometer) 10. A standard flow cytometer can exclude sorting elements of the cell sorter system. In FIG. 1, five major subsystems of the system 10 are shown including an excitation optics system 12, a fluidics system 14, an emission optics system 16, an acquisition system 18, and an analysis system 20. The fluidics system 14 can include a sample loading system (not shown), an interrogating system 28, a cell sorting system 33, and a drop receiving system 29. Generally, a “system” and “subsystem” includes (electrical, mechanical, and electro-mechanical) hardware devices, software devices, or a combination thereof.

The excitation optics system 12 includes, for example, a plurality (e.g., two to five) of excitation channels 22A-22N each having a different laser device 23A-23N and one or more optical elements 24-26 to direct the different laser light to optical interrogation regions 30A-30N spaced apart along a line in a flow channel 27 of a flow cell 28. Example optical elements of the one or more one or more optical elements 24-26 include an optical prism and an optical lens.

The excitation optics system 12 illuminates an optical interrogation region 30 in a flow cell 28. The fluidics system 14 carries a fluid sample 32 surrounded by a sheath fluid through each of a plurality of optical interrogation regions 30A-30N in the flow cell/flow channel.

The emission optics system 16 includes a plurality of detector arrays 42A-42N each of which, for example, includes one or more optical elements 40, such as an optical fiber and one or more lenses to direct fluorescent light and/or (forward, side, back) scattered light to various electro-optical detectors (transducers), including a side scatter (SSC) channel detector and a plurality (e.g., 16, 32, 48, 64) of fluorescent wavelength range optical detectors in each array, such as a first fluorescent optical detector (FL1) receiving a first wavelength range of fluorescent light, a second fluorescent optical detector (FL2) receiving a second wavelength range of fluorescent light, a third fluorescent optical detector (FL3) receiving a third wavelength range of fluorescent light, a fourth fluorescent optical detector (FL4) receiving a fourth wavelength range of fluorescent light, a fifth fluorescent optical detector (FL5) receiving a fifth wavelength range of fluorescent light, and so on to an Nth fluorescent optical detector (FLN) receiving an Nth wavelength range of fluorescent light. Each of the detector arrays 42A-42N receives light corresponding to the cells/particles that are struck and/or one or more fluorescent dyes that attached thereto and excited by the differing laser light in interrogation regions/points 30A-30N along the flow channel 27 of the flow cell 28 by each of the corresponding plurality of lasers 23A-23N. The emission optics system 16 gathers photons emitted or scattered from passing cells/particles and/or a fluorescent dyes attached to the cells/particles. The emission optics system 16 directs and focuses these collected photons onto the electro-optical detectors SSC, FL1, FL2, FL3, FL4, and FL5 in each detector array, such as by fiber optic (optical fibre) cables 39, one or more one or more lenses 40, and one or more mirrors/filters 41. Electro-optical detector SSC is a side scatter channel detector detecting light that scatters off the cell/particle.

The electro-optical detectors FL1, FL2, FL3, FL4, and FL5 are fluorescent detectors may include band-pass, or long-pass, filters to detect a particular and differing fluorescence wavelength ranges from the different fluorescent dyes excited by the different lasers. Each electro-optical detector converts photons into electrical pulses and sends the electrical pulses to the acquisition (electronics) system 18.

For each detector array 42A-42N, the acquisition (electronics) system 18 includes one or more analog to digital converters 47A-47N and one or more digital storage devices 48A-48N that can provide a plurality of detector channels (e.g., 16, 32, 48 or 64 channels) of spectral data signals. The spectral data signals can be signal processed (e.g., digitized by the A/Ds) and time stamped, and packeted together by a packetizer 52 into a data packet corresponding to each cell/particle in the sample). These data packets for each cell/particle can be sent by the acquisition (electronics) system 18 to the analysis system 20 for further signal processing (e.g., converted/transformed from time domain to wavelength domain) and overall analysis. Alternatively, or conjunctively, time stamped digital spectral data signals from each channel that is detected can be directly sent to the analysis system 20 for signal processing.

The system 10 can include a liquid jet breakoff control system 60 as disclosed in U.S. patent application Ser. No. 18/797,275, incorporated herein by reference for all intents and purposes.

The liquid jet breakoff control system 60 can include one or more controllers/processors 50, an LED strobe (flash) light array 56, a flat mirror 57, and a hardware triggered camera 59, coupled in communication together as shown. One controller/processor can control the sorting 33 with the sorting plates 35 in order to move the droplets from a center stream into one of two side streams into containers, such as test tubes 34 or wells of well plate 34. The center stream is a waste stream into which non-sorted material falls. The periodic strobe light from the LED strobe 56 is focused on a point in the mirror so the droplet stream (including fluid jet, droplets, and satellites) out from the flow cell 28 is backlit by the reflected strobe light. The backlighting allows the hardware triggered camera 59 to periodically capture brightfield images of the fluid jet, droplets, and satellites in the droplet stream in response to a selective image capture (shutter) signal in synchrony with the piezoelectric actuator's excitation signal. The camera 59 is a hardware-triggered camera that quickly responds to the selective image capture (shutter) signal. One controller/processor can perform synchronization of a strobe signal and a shutter signal to synchronously control the LED strobe light 56 and the hardware-triggered camera 59. The images captured by the camera can be sent to another controller/processor 50 to perform image processing and morphology analysis of the droplet stream in the image using machine learning and computer vision algorithms. Alternatively, the images captured by the camera can be sent to a computer 21 with a processor executing analysis software 20 to perform image processing and morphology analysis of the droplet stream in the captured image.

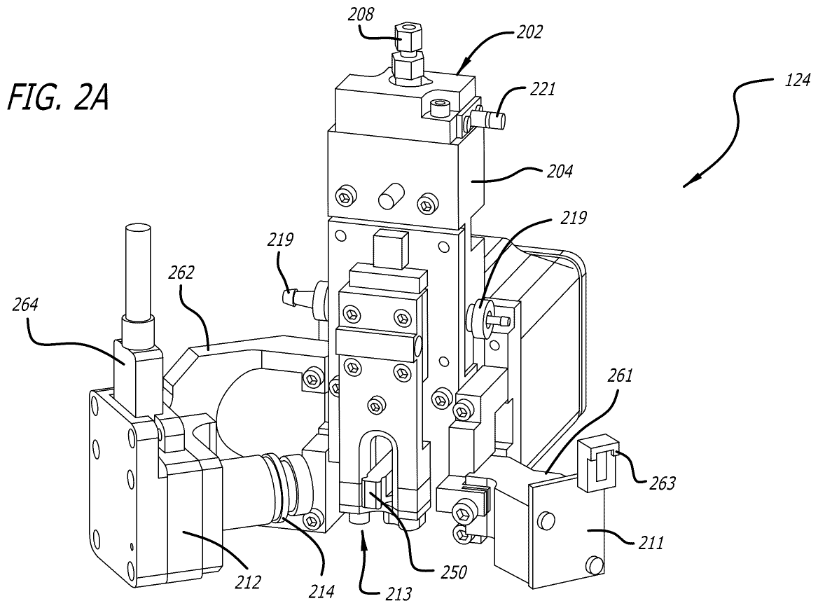

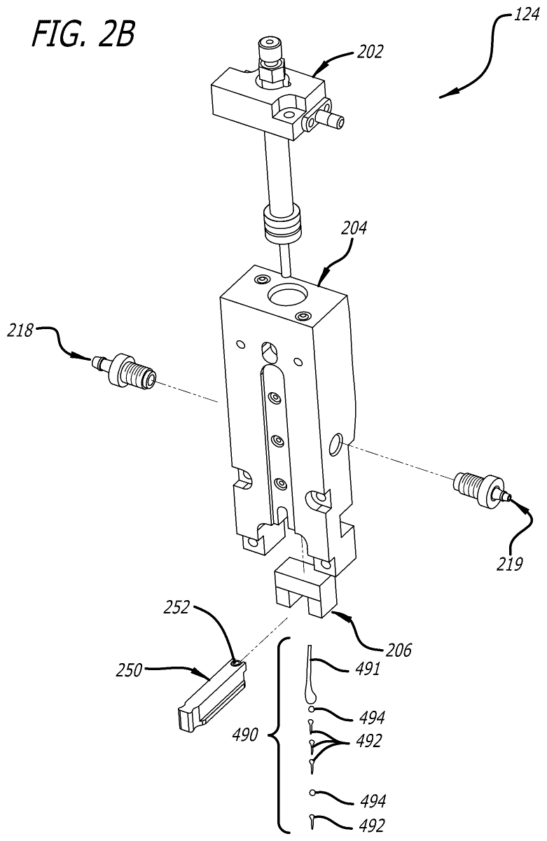

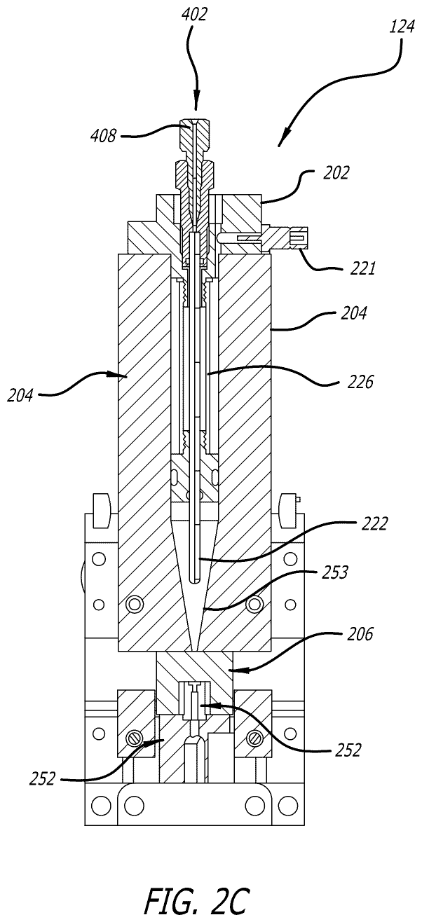

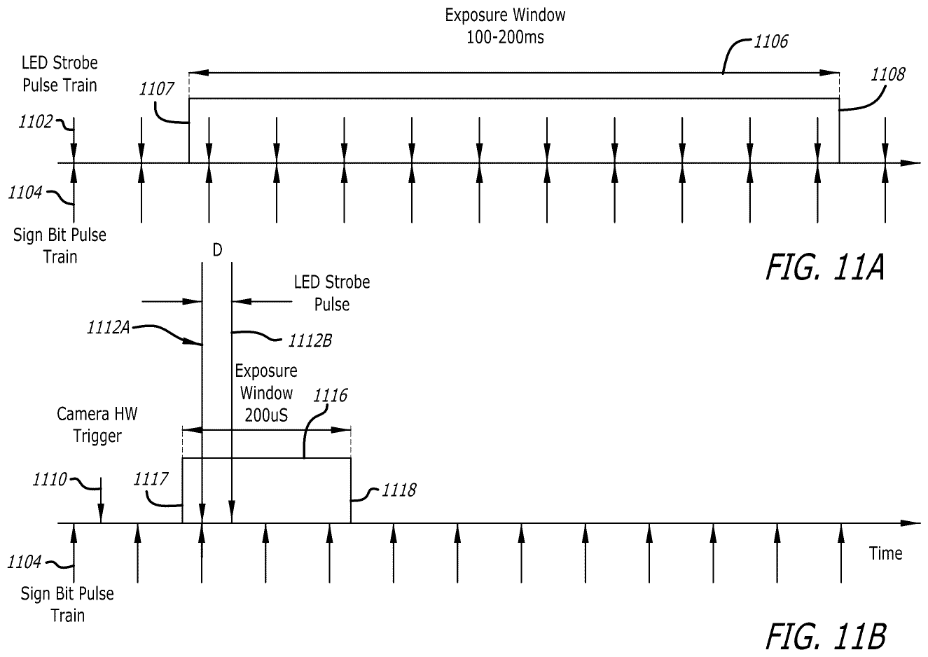

The diffused LED strobe light 56 has a plurality of infrared (IR) light emitting diodes (LED) emitting infrared light and a diffuser in front of the LEDs to generate a diffused infrared LED strobe light in response to a periodically generated strobe pulse signal. (see LED strobe pulse signal 1112 in FIG. 11B and the LED input/output (I/O) connector 263 that includes a wire to receive the periodically generated strobe pulse signal in FIG. 2A). The diffused infrared LED strobe light provides a diffused infrared backlighting of the droplet stream during image capture. The use of IR light avoids interference with other optical components and equipment in the flow cytometer/cell sorter. The diffuser uniformly disperses the white light and spreads it more evenly over the reflective flat mirror 57 to provide improved backlighting.

Assuming the same number, type, wattage, color, and position of LEDs, without a diffuser, the LED bulbs of the strobe light are more like round spot lights focused at the mirror 57. There is a limited space in the flow cytometer/cell sorter and the position of the mirror constrains the optical axis and the number of LEDs that can be used for the LED strobe 56 to provide the backlighting of the drops with the biological cells/particles.

The system 10 can include a droplet deflection control system 70 to control the deflection of drops into test tubes 34 or other drop receiving system 29. The droplet deflection control system 70 can include one or more controllers/processors 50, an LED strobe (flash) light array 72, a hardware triggered camera 74, and a high voltage charger 75 coupled in communication together as shown. The hardware triggered camera 74 is similar to the hardware triggered camera 59. The LED strobe (flash) light array 72 periodically flashes in response to a selective strobe pulse signal 1112 (see FIG. 11B) to provide back lighting of the drops in a droplet deflection unit so images of center drops, and one or more deflected drops can be captured by the hardware triggered camera 74. The camera 74 is a hardware-triggered camera with a global shutter that quickly responds to the selective image capture (shutter) signal (see FIG. 11B). One controller/processor can perform synchronization of a strobe signal and a shutter signal to synchronously control the LED array strobe light 72 and the hardware-triggered camera 74. The images captured by the camera can be sent to the same or another controller/processor 50 to perform image processing and morphology analysis of the droplet stream in the drop images. The same or another controller/processor 50 can use machine learning (unsupervised artificial intelligence) and computer vision algorithms to automatically initialize the drop deflection control of the droplet deflection control system 70 upon startup and can provide real time drop deflection control while a biological sample is processed by the cell sorter. In another case, the drop images captured by the camera 74 can be sent to a computer 21 with a processor executing analysis software 20 to perform image processing and morphology analysis of the drops in the captured images. The formation of drops, by the liquid jet breakoff control system 60 or otherwise, can be synchronized with the droplet deflection control system 70 in order to more accurately charge one or more drops for deflection.

Generally, the droplet deflection control system 70 captures images of drops in a deflection chamber with the synchronized camera 74 and the LED array strobe light 72. The drops in the captured images may be centered drops that are in a center line and/or selective deflected drops that have been deflected along deflection lines for sorting into sorting containers. Each captured image is read into a processor/controller 70 and/or a computer 21 with a graphical user interface to perform image processing and morphology analysis on the drops. Centered drops and deflected drops may not always be along expected centerlines (center axis) and expected deflection lines (deflection axes) respectively. For deflected drops or deflection droplets, there may be a deflection angle error between a measured deflection angle and a desired deflection angle of the deflection of a drop in a deflected droplet stream. For center drops, there may be a center line error between a measured center line and a desired center line of drops in the center stream. With image feedback, the processor/controller 50 calculates the deflection angle error and the center line error to control the angular error of the deflected droplets. Based on the deflection angle error, the processor/controller modulates a charge signal in real time that controls the charge coupled to the jet stream in the flow cell so that the following deflected droplets that break off better approach the reference deflected line, and the deflection angle error is forced towards zero. Based on the center line error, the processor/controller can also variably compensate a charge placed on guard droplets that follow each deflected droplet with an offset voltage of an offset voltage signal or offset charge of an offset charge signal. The goal of the charge compensation on the guard droplets is to force the center line error to zero and keep the centerline of droplets as narrow as possible. The tightness of a train of center droplets or centered droplets is controlled by modulating the droplet-by-droplet charge of the stream of guard droplets.

The analysis system 20 includes a host computer 21 with a display device, a processor, memory, and data storage devices coupled in communication together. The data storage devices can store the data packets of timestamped digital spectral data associated with the detected cells/particles in the sample. The analysis system 20 further includes software with instructions executed by the processor to convert/transform data from the time domain to data in a wavelength/frequency domain and stitch/merge data together to provide an overall spectrum for the cell/particle/dyes excited by the different lasers and sensed by the detector arrays. With detection of the type of cell/particle through the one or more fluorescent dyes attached thereto, a count of the cells/particles can be made in a sample processed by a flow cytometer and/or cell sorter. The data storage devices and memory can also store instructions for execution by the processor. Graphical user interfaces (GUI) can be generated by the processor based on execution of some instructions and then displayed on the display device. A droplet stream control GUI can be displayed on the display device by instructions executed by the processor.

In some cases, it is desirable to sort out the cells in a sample for further analysis with a cell sorter (sorting flow cytometer). Accordingly, the spectral data signals can also be processed by a real-time sort controller 50 in the acquisition (electronics) system 18 and used to control a sorting system 33 to sort cells or particles into one or more test tubes 34. In which case, the sorting system 33 is in communication with the real-time sort controller 50 of the acquisition (electronics) system 18 to receive control signals. Instead of test tubes 34, the spectral data signals can also be processed by the real-time sort controller 50 of the acquisition (electronics) system 18 and used to control both the sorting system 33 and a droplet deposition system 29 to sort cells or particles into wells 35 of a moving capture tray/plate. In which case, both the droplet deposition system 29 and the sorting system 33 are in communication with the acquisition (electronics) system 18 to receive control signals. In an alternate embodiment, the analysis system 20 can generate these control signals from analyzing the spectral data signals in order to sort out different cells/molecules and control the sorting system 33 and the droplet deposition system 29 to capture the droplets of samples with cells/particles into one or more wells 35 of the plurality of wells in the capture tray/plate.

U.S. patent application Ser. No. 15/817,277 titled FLOW CYTOMETERY SYSTEM WITH STEPPER FLOW CONTROL VALVE filed by David Vrane on Nov. 19, 2017, now issued as U.S. Pat. No. 10,871,438; U.S. patent application Ser. No. 15/659,610 titled COMPACT DETECTION MODULE FOR FLOW CYTOMETERS filed by Ming Yan et al. on Jul. 25, 2017; and U.S. patent application Ser. No. 15/942,430 COMPACT MULTI-COLOR FLOW CYTOMETER HAVING COMPACT DETECTION MODULE filed by Ming Yan et al. on Mar. 30, 2018, each of which disclose exemplary flow cytometer systems and subsystems all of which are incorporated herein by reference for all intents and purposes. U.S. Pat. No. 9,934,511 titled RAPID SINGLE CELL BASED PARALLEL BIOLOGICAL CELL SORTER issued to Wenbin Jiang on Jun. 19, 2016, discloses a cell sorter system that is incorporated herein by reference for all intents and purposes.

### Flow Cell Assembly

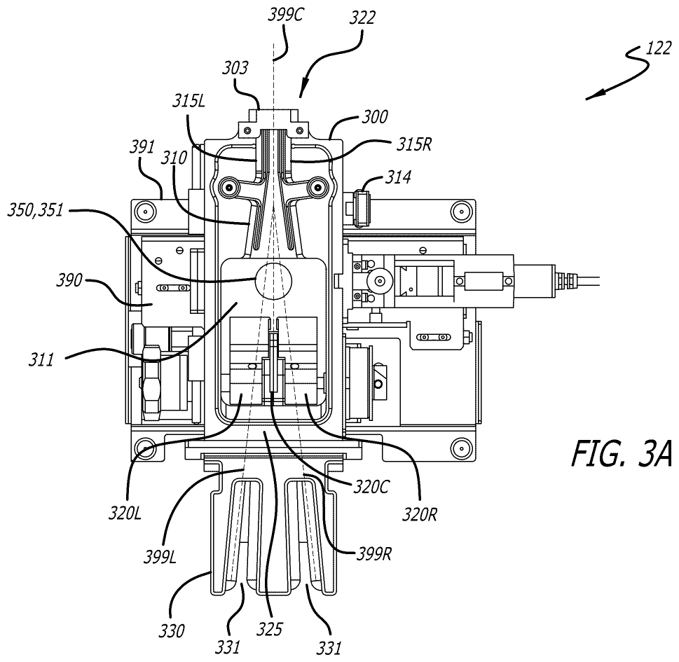

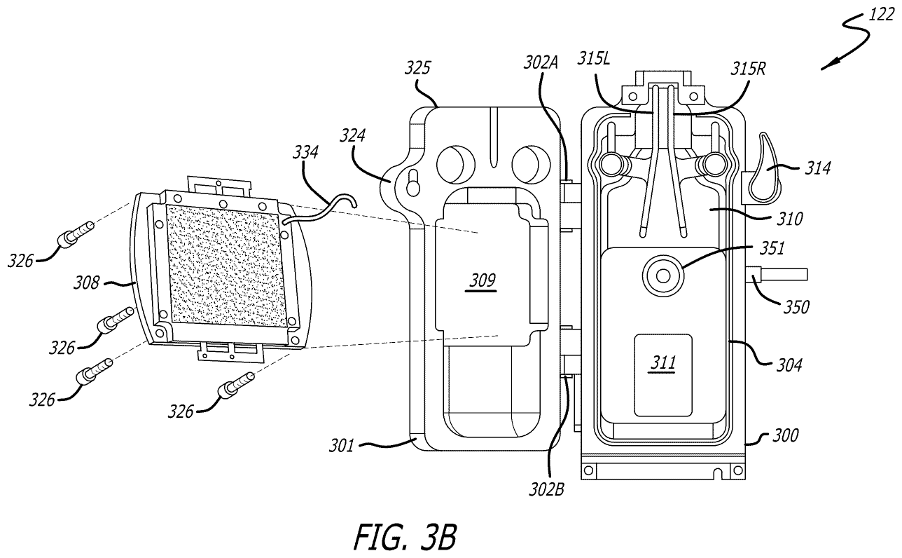

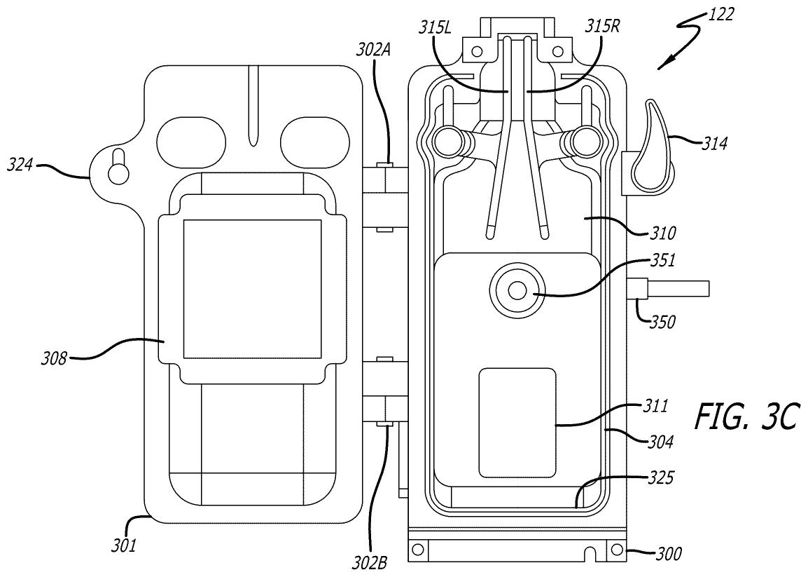

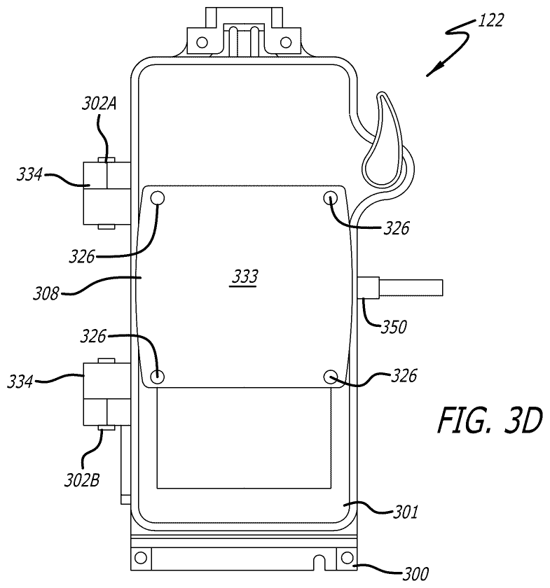

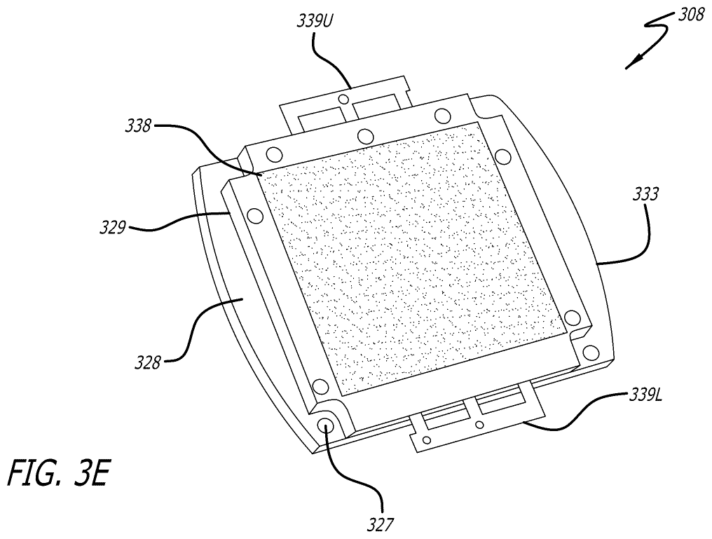

FIG. 2A illustrates a front perspective view of a flow cell 124 of a flow cytometer/cell sorter. The flow cell is coupled in communication with a fluidics subsystem to receive a sheath fluid. A sample biological fluid received at the top of the flow cell flows with cells or particles through the flow cell to be surrounded by the sheath fluid. A droplet deflection unit (DDU) 122 shown in FIGS. 3A-3D is under the flow cell 124 to receive the droplets of the sample biological fluid and sheath fluid. The droplet deflection unit (DDU) 122 includes a deflection chamber to selectively deflect one or more of charged droplets away from the center stream path along one or more deflection paths. A droplet deposition unit is in communication with the deflection chamber 300 to receive selectively deflected droplets in the stream of the sample biological fluid with the one or more biological cells or particles into one or more containers such as test tubes or wells of a plate.

FIGS. 2A-2C illustrate various components of the flow cell 124 without nozzle carriage assembly, its mechanical linkage, and other components that otherwise obscure details that are now discussed. A forward scatter assembly, a final focus lens, and its adjustment are also not shown to avoid obscuring details. The flow cell assembly 124 includes a flow cell body 204, a drop drive assembly 202, a cuvette 206 (see FIG. 2B), a linkage assembly (not shown), a carriage assembly (not shown), and a nozzle assembly 250 with a nozzle having an orifice 252 (see FIG. 2B). The drop drive assembly 202 has a sample input port 208 to receive a hose or pipe that carries the sample fluid. The drop drive assembly 202 further has a sheath input/output ports 219 coupled to the flow cell body 204 each of which receive a hose or pipe. The sheet input port 219 carries sheath fluid into the flow cell body. The sheath output port carries excess sheath fluid, if any, out of and away from the flow cell body. The drop drive assembly 202 is coupled into the flow cell body 204. The drop drive assembly 202 further includes a sample injection tube 222, as shown in FIG. 2C, that directs the sheathed sample fluid towards the orifice 252 in the nozzle body of the nozzle assembly 250 to form droplets of the sample fluid wrapped in a sheath fluid. The flow cell body has a base with a circular opening to allow a stream of the sheathed sample fluid to flow out into the nozzle of the nozzle assembly through a flow channel in the cuvette forming a droplet stream along a fluid axis. A piezo drive cable is coupled to the electrical jack or connector 221 to actuate a piezo electric device (see FIG. 2C) around the injection tube 222.

The flow cell assembly 124 has a number of optical, electrical, and electro-optic components including a hardware triggered camera 212, a diffused light emitting diode (LED) strobe light assembly 211, and a reflective flat mirror 213 for capturing droplet stream images.

The hardware triggered camera 212 is a camera coupled to the flow cell body 204 by a camera mount to hold it in alignment with a camera axis from a point on the flat mirror 213. The hardware triggered camera 212 is equipped with a global shutter and has one or more camera lenses 214 to focus at a point on the axis of droplet stream in front of the flat mirror 213. The hardware triggered camera 212 further has a camera cable to couple a camera trigger signal into the camera hardware and receive image data in return over data signal lines. Instead of being triggered by software timers, the hardware triggered camera 212 as its name implies is a hardware-triggered camera and has a hardware trigger input to receive the camera trigger signal to activate (e.g., on a rising edge to a high pulse level) and deactivate (e.g., on a negative edge to a low pulse level) the capture of digital images like a shutter.

The hardware triggered camera includes a camera chip coupled to a digital trigger signal. The camera chip has a plurality of camera pixels and a global shutter. The global shutter is responsive to the digital trigger signal to begin and end image capture by the plurality of camera pixels. The hardware triggered camera further includes a front enclosure coupled to a mounting bracket, a printed circuit board coupled to the camera chip, a camera body coupled to the printed circuit board, one or more lenses coupled to the camera body and inserted through an opening of the front enclosure, and a back enclosure coupled to the camera body and the front enclosure to enclose the printed circuit board and couple the camera body to the first mounting bracket. The printed circuit board has a first connector to receive the digital trigger signal and one or more metal traces to couple the digital trigger signal to the camera chip. The printed circuit board further has a second connector to couple to a processor to send it still images captured by the camera chip. The one or more lenses are held in alignment over the camera chip to focus the droplet stream onto the active area of the camera chip.

The LED strobe light 211 is coupled to the flow cell body 204 by an illumination mount 261 to hold it in alignment with a strobe light axis into the flat mirror 213 at a point. The LED strobe light 211 includes an optical diffuser to spread the LED light directed towards the flat mirror 213. The LED strobe light 211 has an electrical (LED I/O) connector 263 to receive a strobe trigger signal and control the strobe light generated by the LED bulbs. The optical axes of the LED strobe light 211 and the hardware triggered camera 212 are at a same angle with the face of the flat mirror 213.

The flat mirror 213 is placed behind the orifice 252 in the nozzle assembly 250 so the strobe light generated by the LED strobe 211 backlights the droplet stream exiting out of the orifice of the nozzle assembly. The hardware triggered camera 212 focuses and captures a brightfield image of the droplet stream exiting out of the orifice of the nozzle assembly. The flow cell assembly 124 has a center bracket 265 to keep the camera 212, the LED strobe light 211, the flat mirror 213, and the flow cell body 204 aligned together to consistently capture droplet stream images from the same position. The camera mount 262 is coupled to and between the hardware triggered camera 212 and the center bracket 265 on one side. The illumination mount 261 is coupled to and between the LED strobe light 211 and the center bracket 265 on the opposite side. The flat mirror 213 is mounted to the center bracket 265 in the middle between left and right sides to receive the strobe light from the LED strobe light 211 and reflect it towards the droplet stream from the nozzle orifice 252 and the hardware triggered camera 212.

Laser light from one or more lasers is sent into one or more interrogation regions in the flow channel of a cuvette to excite flowing cells/particles and/or one or more fluorescent dye markers attached thereto that pass by. The flow cell assembly 124 further includes one or more objective lenses in order to capture light (e.g., reflected light, scattered light, fluorescent light) from the cells/particles and/or the one or more fluorescent dyes attached to the cells/particles on one side. The one or more objective lenses can also launch the captured light into a fiber optic cable, so it is directed to photodetectors to analyze the cells and determine their characteristics prior to sorting. The assembly can include a mounting bracket with an opening to receive a side scatter camera.

### Deflection Chamber for Sorting and Image Capture

The nozzle, in the nozzle assembly of the flow cell, breaks up the sheathed sample fluid into droplets. The droplets with cells of interest in a center stream are sorted out by deflecting droplets away from the center stream. The droplets are charged so they can be deflected away from the center stream by charged deflecting plates in the drop deflection unit (DDU) 122. The droplets with cells of interest can be collected into separate vessels (test tubes, wells) by the DDU for further testing in a lab.

FIGS. 3A-3D illustrate views of the drop deflection unit 122. The drop deflection unit 122 is located under the nozzle assembly 250 of the flow cell 124. Accordingly, the drop deflection unit is in communication with the flow cell 124 to receive a plurality of variably charged and/or uncharged droplets of the sheathed sample biological fluid that are in a center stream. As shown in FIG. 3A, the back of the deflection unit 122 is mounted to a rail so that it can be horizontally adjusted from side to side. This can be used to calibrate the deflection unit 122 to the position of a center stream of droplets.

The drop deflection unit 122 includes a case 300 with a door 301 pivotally coupled to the case by a plurality of hinges 302A-302B. The door 301 includes a fastener (e.g., a catch) 324 that can engage a releasable latch 314 on the side of the case to keep the door securely closed against the case. The case 300 has a deflection cone cutout 310 with a top or upper opening 303 to receive the droplets from the flow cell. The cutout further opens up into a deflection chamber 311 of the drop deflection unit. A seal 304 is in a channel around the deflection cone cutout 310 and the deflection chamber 311 to which the door 301 presses against. But for the top opening and a bottom slot opening, the seal 304 seals the sample droplets within the cutout and chamber, so they are not released into ambient air.

A left electrostatic charge (deflection) plate 315L and a right electrostatic charge (deflection) plate 315R are mounted in the deflection cone cutout 310 and are progressively separated further from each other from top to bottom in the cone. A left high voltage charge is applied to the left electrostatic charge plate 315L, and a right high voltage charge of opposite polarity is applied to the right electrostatic charge plate 315R to impose an electrostatic field through which droplets pass. If a droplet is to be sorted by moving it away from a center stream of droplets, a positive charge or a negative charge is synchronously applied to the sample stream by the conductive hose fitting in the drain/charge port and a charge signal from the sort controller before it breaks off from the stream as a droplet. After one droplet breaks off from the stream with one charge, the next droplet that breaks off from the stream can be differently charged through the stream. If the droplets are uncharged (grounded), they remain in the center stream. If a droplet is charged by applying a charge signal (positive or negative) to the charge port on the flow cell, it can be deflected as it passes through the electrostatic field formed by the electrostatic charge plates. The degree of deflection depends on both the magnitude of the electrostatic field imparted by the left and right electrostatic charge plates and the polarity and magnitude of the charge imparted to the droplet by the charge port.

For example, the left electrostatic charge plate may be charged at negative 2000 Volts and the right electrostatic charge plate may be charged at positive 2000 volts to provide a 4000 volt electrostatic field between them. The voltages on the electrostatic charge plates are held constant during a sort of droplets in a sample. Droplets then may be selectively charged instantaneously (by applying charge to the conductive hose fitting in the charge/drain port on the flow cell) to achieve a desired deflection away from center. Accordingly, the precise magnitude and polarity of voltage applied to cells associated with each stream path will depend on the desired direction and magnitude of deflection needed to get the droplet into a receiving receptacle. Accordingly, multiple (e.g., 2, 3, 4, 5, 6) left deflected stream paths and multiple (e.g., 2, 3, 4, 5, 6) right deflected stream paths can be formed about the center stream path. For simplicity of the explanation herein, we will collectively refer to them herein as a left stream path (left stream) and a right stream path (right stream).

Referring to FIGS. 3B-3D, the case 300 of the deflection unit is illustrated with the aspiration components not shown to focus on the components involved with droplet image capture. A backside of the case 300 has a sort camera window 351, in this case a circular window but other shapes can be used, behind which the highspeed hardware triggered sort camera 350 resides. The hardware triggered sort camera 350 includes an electrical cable (e.g., USB cable) to couple to the deflection control system to receive a camera trigger signal and share images that are captured with the controller. A front strobe light is generated by a light emitting diode (LED) array strobe light 308 and is directed into the front of the deflection chamber 311 to back light droplets in front of the sort camera 350. The LED array strobe light 308 includes an electrical cable (e.g., USB cable) to couple to the deflection control system to receive a strobe light trigger signal. A pulsed light is generated by the LED array strobe light 308 that is synchronized with the image capture by the sort camera 350. The pulsed strobe light generated by the LED array back-lights the droplets in the captured images in order to detect their position along the path of the center stream and deflected paths. The light emitting diode (LED) array includes a plurality of light emitting diodes, a printed circuit board coupled to the plurality of light emitting diodes, and a case or housing to hold the printed board. A cable 334 is coupled to the printed circuit board to provide power, ground, control, and a strobe signal to the LED array. The LED array is coupled to the digital strobe signal to be activated and deactivated to form the strobe light. The printed circuit board is coupled to the plurality of light emitting diodes. The printed circuit board has a connector to receive the digital strobe signal and one or more metal traces to couple the first digital strobe signal to the plurality of light emitting diodes.

The sort camera 350 is mounted outside the case 300 in line with and behind the stream camera window 351 to view the droplets and determine whether or not they are in a center stream path, one of the one or more left deflected stream paths, or one of the one or more right deflected stream paths. The sort camera 350 is a hardware triggered camera that includes a camera chip coupled to a digital trigger signal. The camera chip has a plurality of camera pixels in an active area and a global shutter to capture pixel data concurrently in parallel with the plurality of camera pixels. The global shutter is responsive to the digital trigger signal to begin and end image capture by the plurality of camera pixels.

The sort camera 350 generally provides a visual feedback mechanism to the sort controller to be sure the charges on the charge plates are appropriate for deflection of droplets into the one or more left deflected stream paths and the one or more right deflected stream paths, as well as equally charged (or no charge) for dropping in the center stream path inside the deflection unit 122. As further discussed herein, the charges on the droplets can also be altered to compensate and better control the position of deflected droplets and the center stream of droplets.

As shown in FIGS. 3B-3E, the deflection (deflecting) unit 122 includes a pivotal door 301 pivotally coupled to the case 300 by a pair of hinges 302A-302B. An inside portion 329 of the LED array strobe light 308 is mounted into an opening 309 in the pivotal door 301.

The LED array strobe light 308 can be coupled to the outside of the pivotal door 301 by a plurality of threaded fasteners 326, such as screws or bolts, inserted through holes 327 in an external flange 328 of a casing 333. Electrical wiring for power, ground, and a strobe signal can be routed in a cable 334 to the LED array around one of the hinges. A flexible upper flange 339U and a flexible lower flange 339L can extend from the inside portion 329 to position the LED array strobe light 308 within the opening 309. FIG. 3C shows an inside view of the LED array strobe light 308 fitted into the opening 309 in the pivotal door 301. FIG. 3D shows the pivotal door 301 in a closed position with the case 300. It further shows an outside view of the LED array strobe light 308 fitted into the opening 309 in the pivotal door 301.

As shown in FIG. 3E, the LED array strobe light 308 includes an X by Y array of light emitting diodes (LEDs) 338 mounted to a substrate. The substrate is in turn coupled to an inner surface of the casing of the LED array strobe light 308. The electrical wiring, including power, ground, and the strobe signal, is coupled to the driver circuits on the substrate that drive the LEDs 338 in the array. The driver circuits generate a buffered control signal for the LEDs 388 to generate a periodic strobe light synchronized with the shutter signal of the camera.

Referring back to FIG. 3A, at the base of the deflection chamber 311 is an aspirator well (tub) with a drain to aspirate droplets and satellites into the waste line out of the cell sorter. In front and below the tub in the base of the deflection chamber is a horizonal drop slot. Inside the chamber 311, a left pivotal side stream scupper 320L, a non-pivotal center collector 320C, and a right pivotal side stream scupper 320R are mounted along a drive shaft in the tub of the deflection chamber 311. The non-pivotal center collector 320C is around the drive shaft between the left and right pivotal side stream scuppers. The non-pivotal center collector 320C is undriven by the drive shaft. The left pivotal side stream scupper and the right pivotal side stream scupper are coupled to the drive shaft in order to pivot with it. The drive shaft can pivot the left and right pivotal side stream scuppers between a raised position and a lowered position. The non-pivotal center collector 320C is non-pivotal and remains in a fixed rotational position regardless but is free to move left and right with the scuppers. Droplets that are deflected and not captured by the side stream scuppers 320L-320R or the center collector 320C, can fall out of the deflection unit 122 through the drop slot for subsequent collection by test tubes or a well plate.

With no deflection by the deflection plates, the center stream of droplets and satellites from the nozzle assembly drop through the deflection cone 310 into the deflection chamber 311 and are caught by the center collector 320C. The center collector 320C and the side stream scuppers 320L-320R, when in the lowered position, act somewhat like rain gutters directing the flow of droplets of sample fluid. The center collector 320C directs the droplets and satellites it catches into the tub for aspiration down the drain as waste. In a lowered position, the left and right pivotal side stream scuppers 320L-320R catch droplets that are deflected away from the center stream and direct the droplets they catch by means of a tunnel into the tub for aspiration down a drain as waste. The droplets in the tub can be aspirated down the drain and out through a waste port by a vacuum. In a raised position, the left and right pivotal side stream scuppers 320L-320R do not catch any droplets. When left and right pivotal side stream scuppers are in the raised position and selected droplets are deflected away from the center stream as deflected droplets, those deflected droplets of sample fluid drop past the side stream scuppers and through the drop slot (bottom base slot) 325 in the base of the case 300. The deflected droplets pass through the drop slot (bottom base slot) 325 for collection in a chamber with a well plate or test tubes below the deflection unit 122. In the case of an urgent sorter shutdown, the sorter can pivot the shaft and the side-stream scuppers into the lowered position such that they and the center non-pivotal aspirator 320C catch all of the droplet stream (jet stream, droplets, and satellites) of sheathed sample fluid formed by the nozzle assembly 250, whether deflected or not, and direct the droplet stream into a tub for aspiration down the drain and out the waste port.

The droplet deflection unit 122 and its deflection chamber 322 is horizontally adjustable. The deflection unit 122 can be slidingly mounted to a rail and horizontally adjustable from side to side, in order to adjust its position to the center stream path of droplets that enter at a top opening. During calibration, the deflection unit 122 can be horizontally adjusted so that the center stream of droplets is selectively positioned (equidistant or as otherwise desired) between the left charge plate 315L and the right charge plate 315R as the droplets enter the deflection cone cutout 310 in the case 300.

Because the droplets can be initially charged and the charge plates can unequally influence entering droplets even though the plates are charged the same, the left pivotal side stream scupper 320L, the center non-pivotal collector (aspirator) 320C, and the right pivotal side stream scupper 320R are also horizontally adjustable together from side to side together. During calibration, another adjustment knob is also provided to horizontally adjust the position of the scuppers 320L-320R and the center non-pivotal collector (aspirator) 320C together along their drive shaft. Accordingly, without different charges deflecting the center stream of droplets, the center non-pivotal collector (aspirator) 320C can be centered under the center stream of droplets of sample fluid with an adjustment to direct them into the tub and down the drain for aspiration out from the cell sorter through the waste outlet.

Referring to FIG. 3A, the deflected droplets pass through the drop slot (bottom base slot) in the case 300 for collection in a drop collection chamber below the deflection unit 122. Coupled to the base of the case 300 of the deflection unit 122 is a collection retainer in the drop collection chamber. A sort collection holder 330 can be slid into the collection retainer in the drop collection chamber 128. A plurality of test tubes 34, such as shown in FIG. 1, may be inserted into the openings 331 in the sort collection holder 330 to receive the droplets sorted out by the cell sorter. The openings 331 are aligned (front to back in depth) with the drop slot 325 such that test tubes mounted therein can capture droplets of sample fluid.

Droplets in one or more left deflected stream paths may be received in test tubes to the left of center. Droplets in one or more right deflected stream paths may be received in test tubes to the right of center. FIG. 3A illustrates a two-tube sort collection holder 330 coupled to the base of the case 300 with openings 331to hold two test tubes to receive droplets in one left deflected stream path and to receive droplets in one right deflected stream path. More than two openings 331 in the collection holder 330 can be provided to support more than two test tubes. A plate guide can be used instead of a tube collection retainer. The plate guide has a one or more stream path openings in which selected droplets fall through and out of the plate guide. A well plate 35 (such as shown in FIG. 1) with a plurality of wells is moved around underneath the plate guide by the loading system to catch droplets in the one or more wells. A well plate can have a plurality of wells (e.g., 32 or 64) in which to capture droplets with different types of cells/particles. The well plate is moved to align one or more selected wells underneath the respective one or more stream path openings to receive the droplets of sample fluid with the desired cells/particles.

### Droplet Formation and Deflection

The formation of separate droplets from the sheathed sample jet stream is important to control the flow rate of sample fluid and match it to the analysis rate or sorting rate capabilities of a flow cytometer/cell sorter. The sooner separate droplets can be reliably formed the greater the flow rate, analysis rate, and sorting rate can be achieved in the flow cytometer/cell sorter. Also, the more stable the location of the liquid jet break-off, the higher the reliability and accuracy of the droplet sort process. A device in a flow cytometer/cell sorter that can more reliably form independent droplets from the sample stream is a piezo-electrical device around a sample injection tube (SIT) that vibrates in response to a piezo drive signal.

Referring now to FIGS. 2A-2B, the fluid ports for the flow cell 124 are shown. The flow cell 124 receives the sample fluid through a sample input port 208 of the drop drive assembly 202. The flow cell 124 receives the sheath fluid through a sheath input port (carrier injection inlet) 218. The flow cell 124 surrounds a stream of the sample fluid with sheath fluid. The flow cell 124 can include a conductive drain port fitting (sheath input port, sheath output port or air purge outlet) 219 threaded into the drain port of the flow cell body 204 to evacuate fluids from chambers inside the flow cell, and to impart charge onto the droplets of sheathed sample fluid with a cell/particle. An electrical wire and a hose can both couple to the conductive drain port fitting (sheath input port, sheath output port or air purge outlet) 219. The electrical wire is in communication with a sort controller to receive a charge signal that is synchronized with the droplets. Over time and droplet formation, the charge signal can be varied as part of a control system to better control the droplet deflection in the deflection chamber of the deflection unit 122. In response to images captured of deflected droplets, the drop stream can be grounded or charged through a conductive electrode (variable electrical charge) to varying levels of positive charge voltages (e.g., such as between zero and positive 300 volts), or varying levels of negative charge voltages (e.g., such as between zero and negative 300 volts) to respectively keep a droplet uncharged, to positively charge a droplet, or to negatively charge a droplet. Either the drain port (sheath output port or air purge outlet) 219 or the sheath inlet port 218 can function as the charge port.

The nozzle assembly 250 above and in front of the flat mirror 213, includes a nozzle 252 with an orifice to receive the sample stream surrounded by the sheath fluid (sheathed sample stream) and form a droplet stream 490 below it. The droplet stream 490 formed by the nozzle 252 and its orifice fall in front of the flat mirror 213 so a diffused LED strobe light 211 can backlight the droplet stream 490. The hardware triggered camera 212 can capture an image of the droplet stream 490 with a diffused backlight provided by the diffused LED strobe light 211. The diffused LED strobe light 211 includes a plurality of light emitting diodes, a printed circuit board coupled to the plurality of light emitting diodes, an optical diffuser, and a hollow housing with a hollow reflective chamber to hold the printed circuit board with the LEDs and the optical diffuser in alignment together to form a diffused strobe light.

The droplet stream 490 can include a jet stream 491 and one or more droplets 492. The droplet stream 490 can include one or more satellites 494, if any, that are smaller than the droplets 492. The size of the one or more droplets 492 in the droplet stream 490 is related to the orifice in the selected nozzle 252. The nozzle assembly 250 is interchangeable so different nozzles with different sized orifices can be used for different sized droplets.

Referring now to FIG. 2B, an exploded view of the flow cell subassembly 124 is shown. The flow cell 124 has a ground connection to shield the sample fluid from charges being generated by the deflection unit and to remove charges that may have been already present prior to charging. The flow cell subassembly 124 includes a drop drive assembly 302, a flow cell body 204, a cuvette 206, and a nozzle assembly 250 in order to generate a droplet stream 490 and the drops or droplets 492 that break off therefrom.

The flow cell body 204 of the flow cell 124 receives the drop drive assembly 202. The drop drive assembly 202 includes a sample injection tube (SIT) 222. The drop drive assembly 202 includes a sample input port 208 to receive the sample fluid. The sample injection tube 222 is centered in a chamber within the flow cell body 204. The sample injection tube 222 is preferably formed of glass to avoid surface etching in the presence of electrical currents in the sheath fluid for droplet charging and vibration of the drop-drive for droplet separation that can cause leakage.

The cuvette 206 includes a flow channel with an interrogation region to allow a sample stream of cells with a sheath fluid to be examined. The cuvette 206 is transparent so that one or more lasers can strike the moving cells in the sample stream with scattered light and fluorescent light being captured by a plurality of detectors.

The nozzle assembly 250 slides in and out of a mount under the cuvette to receive the sheathed sample stream out of the flow channel in the cuvette. The nozzle of the nozzle assembly includes the orifice to receive the flow of sheathed sample fluid from the cuvette and forms droplets 492 from the droplet stream 490 of the sheathed sample fluid below it. Each droplet preferably has a single cell/particle that can be sorted.

Referring now to FIG. 2C, a cross-sectional view of portions of the flow cell assembly 124 including the drop drive assembly 202 is shown. The flow cell 124 includes the flow cell body 204, the drop drive assembly 202, a cuvette 206, and a nozzle assembly 250 with the orifice 252 in a nozzle. The cuvette 206 has a flow channel to allow a fluid stream (sheath fluid around sample fluid) from the flow cell body to flow through into the orifice 252 in the nozzle assembly 250.

The drop drive assembly 202 includes a metal hub 1402 that couples it to the flow cell body 204. The drop drive assembly 202 further includes a sample injection tube (SIT) 222 having one end inserted an opening of the hub 1402 and a sample input port. At one end, the SIT receives sample fluid through the sample input port 208 from a tube or hose. The lower portion of the drop drive assembly below the hub 1402 is inserted into a fluid chamber of the flow cell body 204. A lower end of the sample injection tube 222 is located in a funnel portion 253 of the fluid chamber. From the lower end of the sample injection tube 222, sample fluid can be injected into the center of sheath fluid in the funnel portion and flow out of a base opening in the fluid chamber and out from the flow cell body 204 into the cuvette 206.

The drop drive assembly 202 further includes an electrical jack (connector) 221 and a hollow piezoelectric cylindrical transducer 226 both of which are mounted to but electrically insulated from the metal hub 1402. A positive terminal of the electrical jack (connector) 221 is electrically coupled to a positive terminal of the hollow piezoelectric cylindrical transducer 226. A negative terminal of the hollow piezoelectric cylindrical transducer 1406 is coupled to a negative terminal of the electrical jack (connector) 221. An insulated cylindrical sealing base is coupled to an opposite end of the hollow piezoelectric cylindrical transducer 226. The insulated cylindrical sealing base has a sealing O-ring to keep fluids away from the hollow piezoelectric cylindrical transducer 226. The lower end of the sample injection tube 222 extends through the insulated cylindrical sealing base so it can be injected into the center of sheath fluid in a funnel portion 253 of the flow cell body 204.

The hollow piezoelectric cylindrical transducer 1406 is an instance of a piezoelectric device referred to herein that can impart vibrations into the sheathed sample stream. The hollow piezoelectric cylindrical transducer 226 mounts around a portion of the SIT 222 when assembled together. Vibrations from the hollow piezoelectric cylindrical transducer 226 at one end can be mechanically coupled into the hub of the drop drive assembly 202 and the sample injection tube 222 through which it is inserted. Vibrations from the hollow piezoelectric cylindrical transducer 1406 at an opposite end can be coupled into the insulated cylindrical sealing base 1408 and the sample injection tube through which it is inserted. Sample fluid with cells/particles flows within the hollow center cylinder of the SIT 222. The vibrations from the hollow piezoelectric cylindrical transducer 226 are also exerted onto the sheathed sample fluid and travel to generate acoustic waves that propagate in the fluidic medium through the nozzle orifice down to the liquid jet causing the jet to break off and form droplets at varying rates out of the orifice 252.

The sheathed sample fluid receives acoustic energy that can help convert the sheathed sample fluid into a stream of small droplets spread out in a single file line out of the orifice of the nozzle. Ideally, each droplet has a single cell/particle, but cells/particles of interest can vary in size. The diameter of the opening in the nozzle, the sheath pressure, and fluid viscosity can vary the size of droplets, whereas the frequency of vibrations in the piezo device determine their frequency of generation. For a given sheath fluid pressure, the AC signal frequency and amplitude of an AC piezo drive signal can be set for resonance where droplets form more readily, and are more stable over time. The nozzle assembly can be readily swapped in and out to get a different diameter of nozzle opening for different droplet sizes.

The hollow piezoelectric cylindrical transducer 226 receives an alternating current (AC) piezo drive signal through the terminals of the electrical jack (connector) 221. The drive signal is a high powered alternating current (AC) signal (amplitude and frequency selectable) from the electronics in the system. The drive signal has high current and voltage capabilities in order to effectively vibrate the piezo device. The hollow piezoelectric cylindrical transducer 1406 vibrates based on frequency and amplitude of the high powered electrical AC drive signal. The frequency of the high powered electrical drive signal can be selectively varied and therefor vary the frequency of vibrations of hollow piezoelectric cylindrical transducer 1406 that are transferred into the sheathed sample stream. A signal amplitude of the high powered electrical drive signal can be selectively varied and therefor vary amplitude of vibrations of hollow piezoelectric cylindrical transducer 1406 that are transferred into the sheathed sample stream.

The frequency of the drive signal can be used to vary the formation rate of droplets out from the orifice 252 in the nozzle assembly. At a given drive frequency and sheath pressure, the amplitude of the drive signal can be used to vary the location of the jet break-off point and the droplet interval described herein.

U.S. patent application Ser. No. 17/665,480, titled INTEGRATED COMPACT CELL SORTER, filed on Feb. 4, 2022, by inventors Glen Krueger et al., incorporated herein by reference, discloses further information regarding the flow cell including the flow cell body, the drop drive assembly, and the sample injection tube (SIT).

### Led Strobe Light and Hardware Triggered Camera

FIG. 1 introduced a flat mirror 57,213, a first digital camara 59,212, and a diffused LED strobe light 56,211 of the cell sorter/flow cytometer. The first digital camera is a synchronized hardware triggered camera 212 that is synchronized with the diffused LED strobe light 211 to provide visual feedback for a liquid jet breakoff control system. With the visual feedback, the liquid jet breakoff control system can better control the piezo-electric device and the formation of independent droplets of sample fluid surrounded by sheath fluid in the droplet stream from the flow cell and the sample injection tube (SIT). Additional details of the liquid jet breakoff control system, including camera and strobe light synchronization, are described in U.S. (U.S.) Ser. No. 18/797,275 titled IMAGE CAPTURE AND AUTOMATED REGULATION FOR LIQUID JET BREAKOFF IN CELL SORTERS filed on Aug. 7, 2024, by inventor Mohammad N. Saadatzi.

FIG. 1 also introduced a second digital camera (sort camera 74,350) and a second LED strobe light (LED array 72,308) in order to image droplets in flight inside the deflection chamber to provide visual feedback for the purpose of drop deflection control. The sort camera 350 is a second high speed hardware triggered digital still camera in the system. The sort camera 350 is mounted to a back portion of a deflection chamber with its lens facing out of the page behind a window 351. The sort camera 350, similar to the synchronized hardware triggered camera 212, can be synchronized with the LED array strobe light 308 to capture images of droplet deflection in the deflection chamber. However, the LED array strobe light 308 to generate a strobe light to provide back lighting of the droplet streams in the deflection chamber differs from the diffused LED strobe light 211. In comparison with the diffused LED strobe light 211, the LED array strobe light 308 is larger with more light emitting diodes to cover a larger area and need not include a diffuser.

The hardware triggered camera can be a BASLER DART USB 3.0 camera module with an ONSEMI AR0134 camera sensor (chip) having model number daA1280-54um, for example. The ONSEMI AR0134 camera sensor (chip) is a progressive scan CMOS sensor with a global shutter causing all pixels to be exposed at the same time and all pixels to stop being exposed at the same time during an exposure time period. The pixels thereafter can be readout during a readout time period. A universal serial bus (USB) cable can connect to the camera for bidirectional communication.

The camera receives a hardware trigger signal that is a pulse signal with a short time period. The hardware trigger signal triggers the camera chip in the camera to capture data from all pixels in the active area simultaneously in parallel in the short time interval. Frequent and periodic visual inspection of the droplet stream by the droplet control system ensures proper regulation of the jet breakoff location and droplet interval. The hardware trigger signal for the hardware triggered camera appropriately timed with or in synchrony with the LED strobe light trigger is the way to do so.

The LED array strobe light 308, discussed herein with reference to FIGS. 3A-3E and elsewhere, is a larger two dimensional array of LED elements when compared with the LED strobe light 211. It has a broader illumination field to provide backlighting in order to better capture one or more deflection axes and their angles off of a center stream axis. Given the larger array and larger illumination field, a diffuser used for the LED strobe light 211 is not needed over the LED array to smooth out and flatten the backlight. However, a diffuser can be used over the array of LEDS in the LED array strobe light 308.

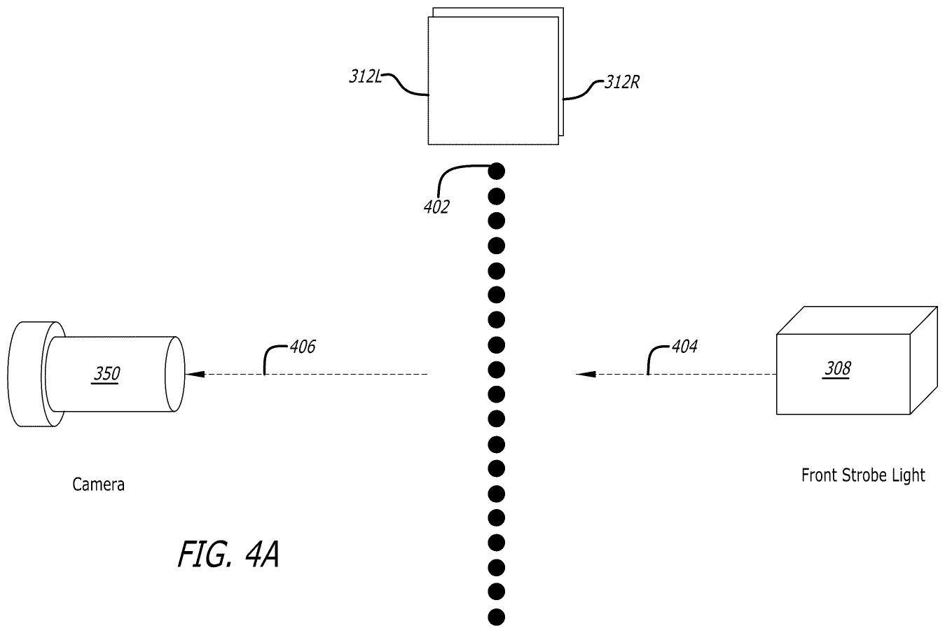

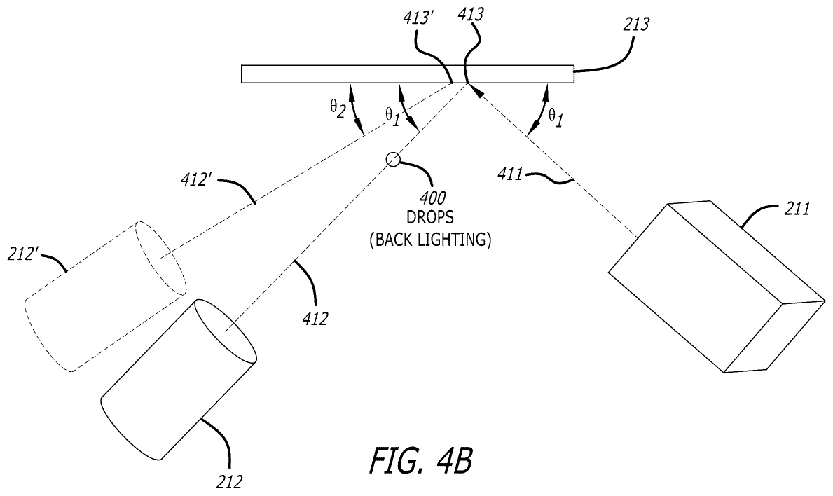

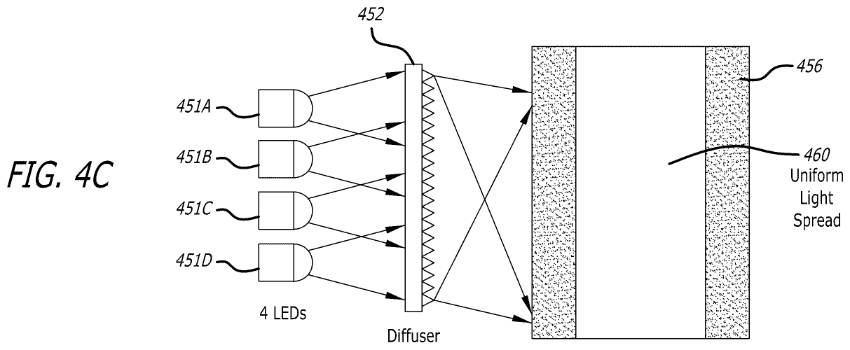

Referring now to FIG. 4A, a schematic diagram (side view) of the image capture of droplets 402 in the deflection chamber 311 is shown isolated from other components of the cell sorter/flow cytometer. A front strobe light is provided by the LED array strobe light 308.

Images of the droplets 402 are periodically captured by the sort camera 350. The shutter signal for the sort camera 350 to capture images is synchronized to the strobe signal for the LED array strobe light 308. An optical axis 404 through the center point of the LED array strobe light 308 is in line with the optical axis 406 of the camera 350. The front strobe light provides back lighting of the droplets 402 so that a bright field image of the droplets 402 can be captured, including any deflected droplets, in the field of view of the droplet chamber below the angled pair of spaced apart deflection plates (negative high voltage deflection plate and positive high voltage deflection plate) 312L-312R.

The angled pair of spaced apart deflection plates (spaced part charge plates) 312L,312R are spaced apart and charged to opposite voltages to create a constant electric field and deflect charged droplets (into and out of page in the side view that is shown) in the droplet stream on one or more desired deflection axes on an angle with the center fluid axis. The left deflection plate 312L can be charged to a negative high voltage while the right deflection plate 312R can be charged to a positive high voltage to form an electric field between them to deflect charged droplets. Alternatively, the right deflection plate 312R can charged to a negative high voltage while the left deflection plate 312L can be charged to a positive high voltage to form an electric field between them to deflect charged droplets.

In FIG. 4B, a top view of the diffused LED strobe light 211, flat mirror 213, and camera 212 better show how drops 400 in a droplet stream along the fluid axis 499C are backlit by the diffused strobe light from the diffused LED strobe light 211. The diffused LED strobe light 211 shines the diffused strobe light into the flat mirror 213 along a strobe axis 411 into a vertical axis 413. The reflection of the diffused strobe light from the flat mirror 213 backlights the droplet stream 400 along a camera axis 412 with the camera 212 from the vertical axis 413. At the vertical axis 413 along a surface of the flat mirror 213, the diffused LED strobe light 211 and camera 212 can be aligned together so that the respective optical axes 411,412 of each is at a similar (equivalent) angle (e.g., theta one angle) with a plane surface of the flat mirror. In other cases, they can be aligned at different vertical axis 413,413′ at the flat mirror 213 with optical axes 411,412′ at dissimilar (inequivalent) angles (e.g., theta one angle and theta two angle). The fluid axis 499C can intersect the camera axis 412 at a substantial perpendicular angle. However, the camera axis 412 can also be slightly offset from the fluid axis 499C and not at a perpendicular angle, while a suitable droplet stream image can still be captured. Moreover, a center optical axis of the camera chip in the camera can be slightly offset from the camera axis 412 and a suitable droplet stream image can still be captured by it.

In FIG. 4C, four LEDs 451A-451D are spaced apart with an optical diffuser 452 over them into which the light from the four LEDs forms an image 456 as shown. The optical diffuser 452 is framed around the LEDs by a frame. The diffuser 452 spreads out the light from each of the four LEDs into a diffused light that shines into the flat mirror 213. An image 456 is captured of the backlighting provided by the four LEDs 451A-451D with the diffuser 452. The image 456 illustrates a substantially even and uniform light spread 460 provided by the diffused light from the diffuser and the four LEDs. Accordingly, the backlighting for the droplet stream is substantially uniform in a vertical direction over which they fall. The vertical distance over which the droplet stream image is captured can be larger with the substantial uniform backlight than that of a spotty backlight generated without a diffuser.

### Droplet Deflection

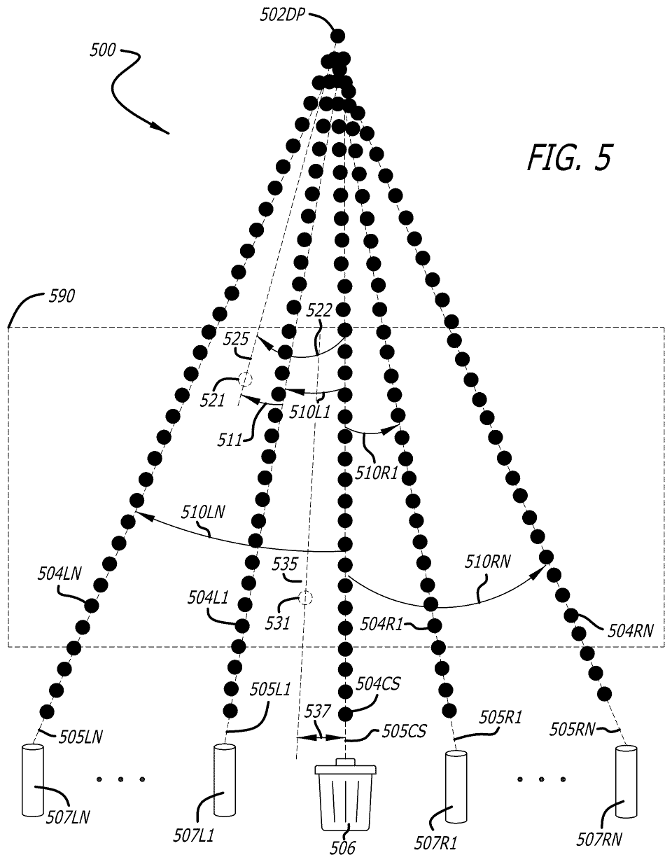

Referring now to FIG. 5, a plurality of droplets fall along various fluid axes (lines) below the pair of spaced apart charge plates. A center stream 504CS of droplets fall from a starting point 502DP along a center stream axis or a reference center line 505CS. If droplets are left uncharged, and hence undeflected by the electric field formed by the charge plates, they continue to fall along the reference center line and into an aspiration or waste bucket 506. One or more of the droplets can be charged and deflected to the left of the center stream 504CS along one or more left reference deflected lines (deflection axis) 505L1-505LN so they can be collected by one or more left sorting containers 507L1-507LN (e.g., wells of a plate, or test tubes). The one or more left reference deflected lines 5051-505LN set up one or more left reference deflection angles 510L1-510LN with respect to the reference center line 505CS. One or more of the droplets can be charged and deflected to the right of the center stream 504CS along one or more right reference deflected lines (deflection axes) 505R1-505RN so they can be collected by one or more right sorting containers 507R1-507RN (e.g., wells of a plate, or test tubes). The one or more left reference deflected lines 505L1-505LN set up one or more left reference deflection angles 510L1-510LN with respect to the reference center line 505CS.

The synchronized sort camera captures a droplet deflection image in a field of view 590 of the deflected droplets in the droplet chamber. The processor/controller of the deflection control system extrapolates back to the deflection point 502DP, and obtains measured deflection angles of drops. The measured deflection angle of each drop is determined by measuring an angle or a distance from a center point of each deflected droplet in a noiseless binary image to the nearest desired deflection axis (line) of a plurality of desired deflection axes. The deflection angle with the center droplet stream can also be determined given the pixel position of the deflected droplet and its projection onto the center stream from the deflection point 502DP, determining the ratio of distances, and taking the inverse tangent of the ratio.

The processor/controller compares the measured deflection angles of droplets with the desired reference deflection angle to obtain a deflection angle error, if any, between them. For example, drop 521 was supposed to be deflected along reference deflection line 505L1 but instead was deflected along line 525 due to an inappropriate charge on the drop 521. Instead of deflection angle 510L1, drop 521 is at line 525 with a deflection angle 522. The difference between the measured deflection angle 522 and the reference deflection angle 510L1 is a deflection angle error 511. The software and processor/controller calculates compensation in real time for the charge to apply on future drops that are expected to be deflected along the reference line 505L1. This is so they move back towards the reference line 505L1 and are properly collected by the respective sorting container.

For center drops, the processor/controller of the deflection control system obtains a center line error 537 from the images between the expected reference center line 505CS and a measured center line 535 through one or more drops 531. The software and processor/controller calculate compensation in real time for a charge to apply on future drops that are expected to fall along the reference center line 505CS. In any case, the charge compensation is provided so that the center drops move back towards the reference center line 505CS and are properly collected by the aspiration bucket 506.

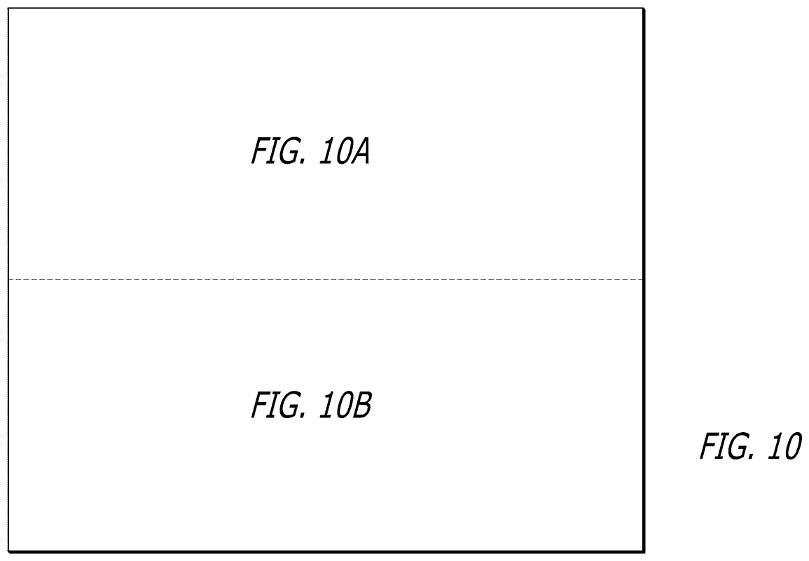

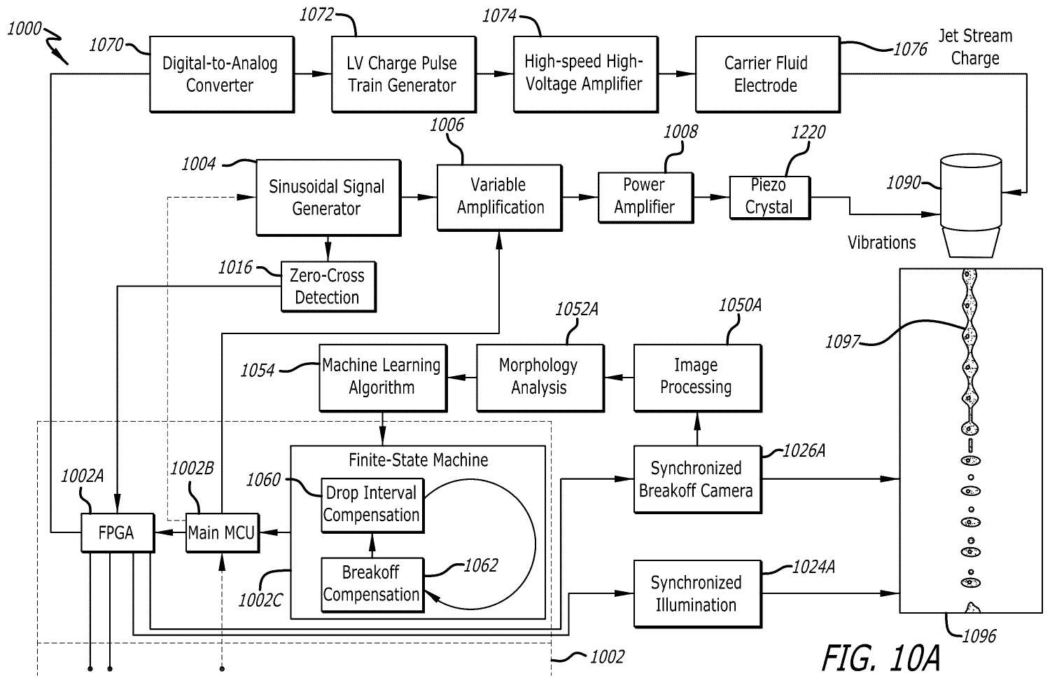

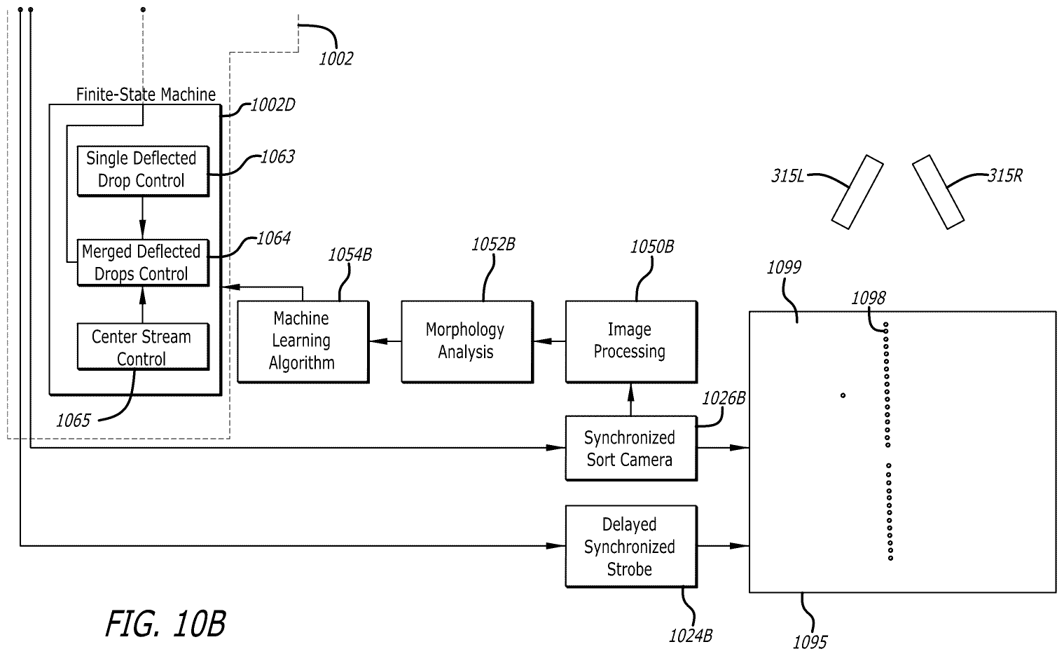

A processor/controller, such as processor/controller 50 shown in FIG. 1 (and controller 1002 shown in FIG. 10, calculates the deflection angle error and the center line error. Based on the deflection angle error, the processor/controller modulates a charge signal in real time that controls the charge coupled to the jet stream in the flow cell so that the following deflected droplets that break off better approach the reference deflected line, and the deflection angle error is forced towards zero. Based on the center line error, the processor/controller can also compensate a charge placed on guard droplets that follow each deflected droplet, and/or the charge applied to charge plates in the deflection chamber. The goal of the charge compensation is to force the center line error to zero and keep the centerline of droplets as narrow as possible.

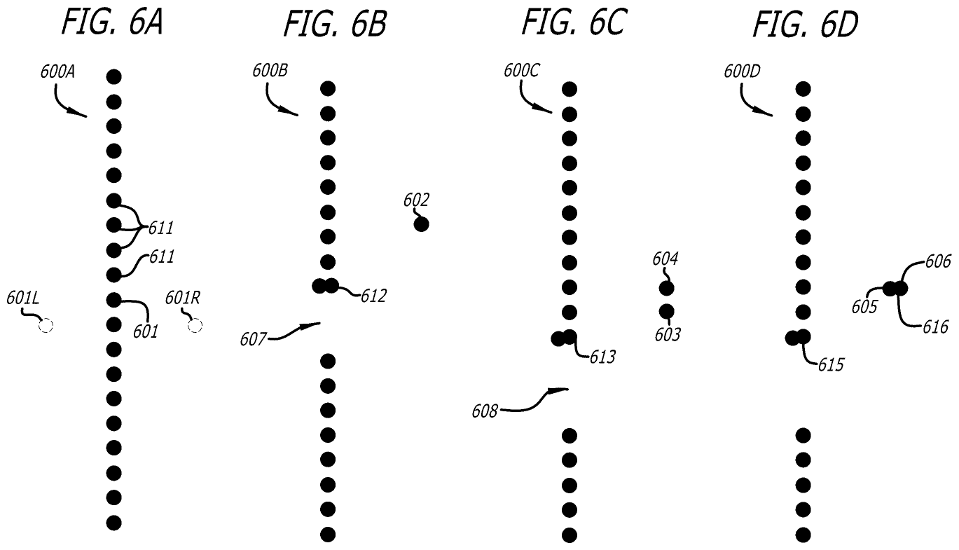

Referring now to FIGS. 6A-6D, various drop streams 600A-600D are shown to explain some issues that can arise with the deflection of a charged drop. In FIG. 6A, it may be desirable to deflect a droplet 601 to the left of center as a left deflected droplet 601L or to deflect the droplet 601 to the right of center as a right deflected droplet 601R. In either case of a left deflected droplet 601L or a right deflected droplet 601R, similar issues can arise during deflection.

Generally, when a drop is deflected, it changes the aerodynamics of the droplet stream. The deflected droplet no longer flows in the center stream of drops. The deflected droplet no longer is in the draft of the drops fallen before it. In FIG. 6B, a droplet 602 has been deflected off from the center droplet stream 600B leaving a gap 607 or opening between drops. The droplet 602 experiences drag so it falls more slowly than that of the center stream of droplets so in the sequence of droplets. Accordingly, it can move up one more droplets in the order of droplets away from the gap 607 such as shown in FIG. 6B. The droplet just above the gap that follows after the deflected droplet, experiences more airflow resistance (drag). This can cause it to merge together with the droplet above it (the following droplet) in the center stream 600B, such as shown by the merged droplets 612 in the droplet stream above the gap 607 shown in FIG. 6B.

It may be desirable to deflect one or more drops in a row or sequence within the center stream in order to sort them into one or more sorting containers. In FIG. 6C, a pair of droplets 603-604 in series have been deflected off from the center droplet stream 600C.

Deflecting two droplets, results in a larger air gap 608 in the center droplet stream 600C. Two or more droplets that follow the larger air gap can group together and form doublets, triplets, or quadruplet droplets (doublets of droplets being the more common). In FIG. 6C, a pair of droplets in series of the center stream have formed a doublet droplet 613.

In some cases, when deflecting two or more droplets in a row, the deflected droplets themselves in the same deflection path can merge together into doublets, triplets, or quadruplet droplets (generally referred to as merged droplets). In FIG. 6D, a pair of droplets 605-606 been deflected off from the center droplet stream 600D and have merged or grouped together as a doublet 616. When deflecting droplets in series, it is desirable to deflect them into different paths, if possible, to avoid them merging together. Alternatively, deflection rules can be established to keep droplets from merging. For example, a deflection rule to deflect every nth droplet (e.g., every fourth) and avoid deflecting adjacent droplets to keep droplets from merging can be enforced by the deflection control system. In FIG. 6A, with droplet 601 selected to be deflected, one or more guard droplets 611 in the center stream after droplet 601 may be forced to remain in the center stream and not deflected because they are likely to merge together and result in poor sorting if they were deflected.

### Image Analysis with Machine Learning

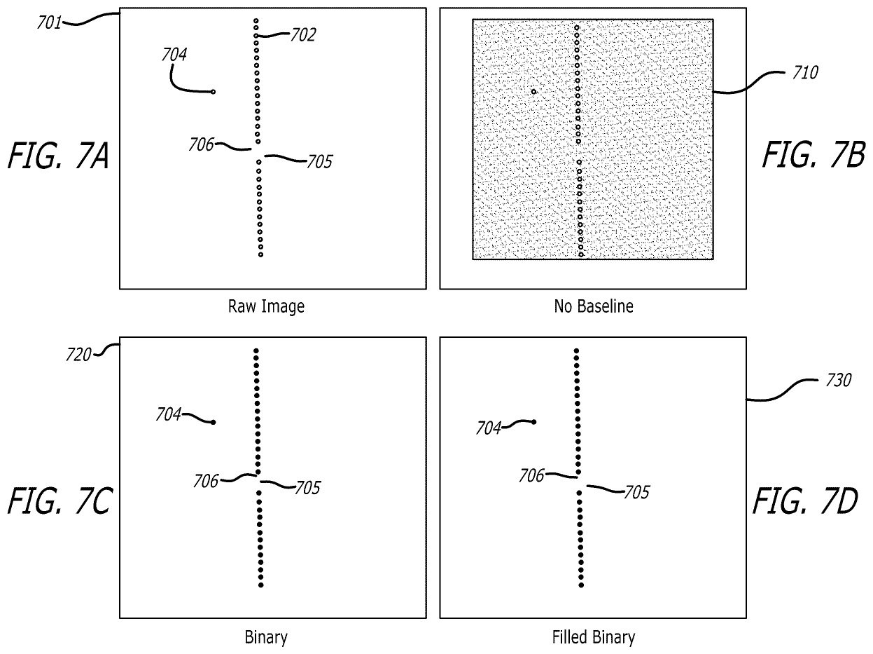

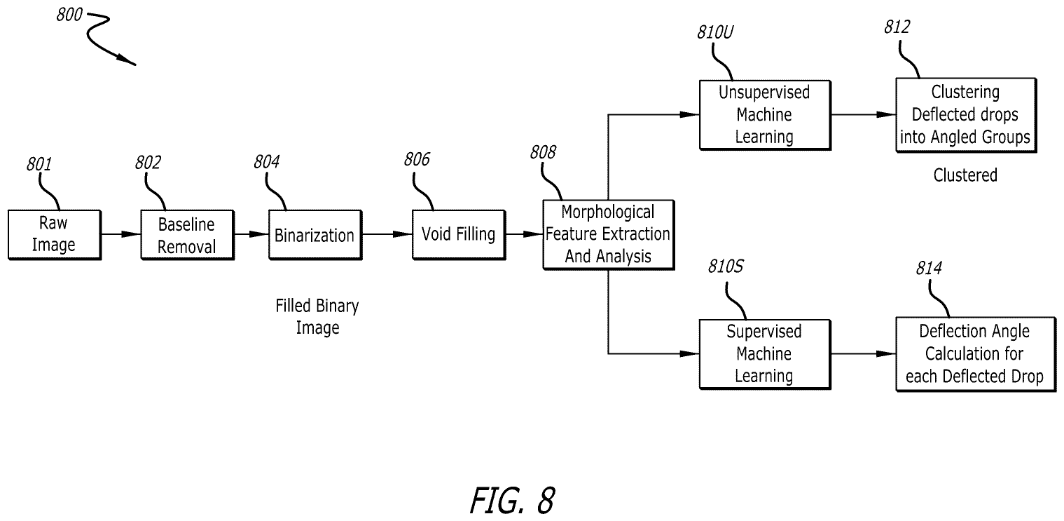

Referring now to FIGS. 7A-7D, 8, and 9, the image analysis performed by the drop control system for droplet deflection control is now described. Details of image analysis for the liquid jet breakoff control system are described in U.S. (U.S.) patent application Ser. No. 18/797,275 titled IMAGE CAPTURE AND AUTOMATED REGULATION FOR LIQUID JET BREAKOFF IN CELL SORTERS filed on Aug. 7, 2024, by inventor Mohammad N. Saadatzi, incorporated herein by reference for all intents and purposes. FIG. 8 illustrates an image analysis process 800 performed by the drop control system for droplet deflection control.

At step 801 of image analysis process 800 shown in FIG. 8, a raw image is captured and sent to the image processing unit. In FIG. 7A, a raw image 701 of a droplet stream 702 is captured by the hardware triggered digital camera with the LED array strobe light providing backlighting in the deflection chamber of the drop deflection unit. The raw image shows a droplet 704 being deflected from the center stream forming a gap 705 in the center stream and a doublet 706 of droplets in the droplet stream 702. The raw image 701 is communicated by the camera to the image processor.

At step 802 of the process, the baseline in the raw image 701 is removed resulting in the baseless image 710 shown in FIG. 7B. The background is black, and the droplets are white in the baseless image 710 without the baseline. The foreground is further segmented from the background by detecting the foreground and blanking out the background in the baseless image 710.

At step 804, a binary image process is performed on the baseless image 710 resulting in a binary image 720 shown in FIG. 7C. The edges of the droplets in the binary image 720 are now well formed so that the deflected droplet 704, the gap 705, and doublet 706 are well defined. The interior of the droplets in the binary image 720 may still have clear or white areas (noise) that need filling.

At step 805, a void filling process is performed on the binary image 720 in FIG. 7C to form a filled or noiseless binary image 730 shown in FIG. 7D. The filled or noiseless binary image 730 has any voids of white or clear areas filled with black so that each droplet has a shade of solid black on a white background. With the image processing of the raw image complete, the process can continue with analysis of the droplets in the image of the filled or noiseless binary image 730.

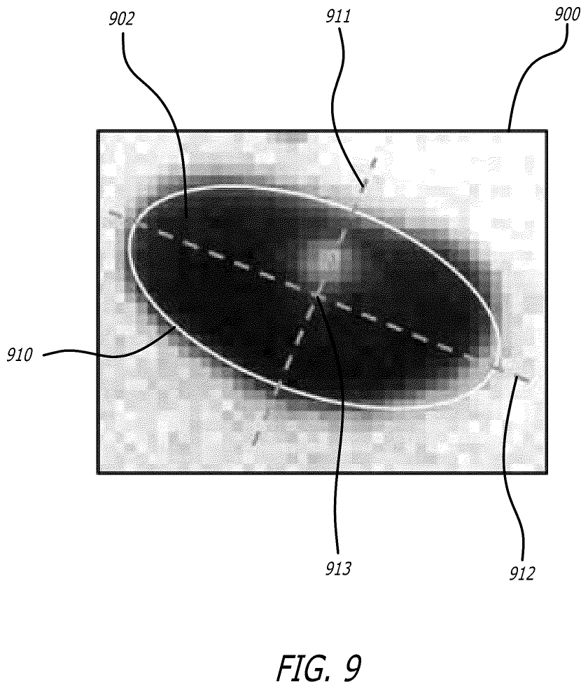

Referring now to FIGS. 8-9, a morphological feature extraction and analysis process 806 can be performed on the filled binary image 730. Each droplet of the droplet stream 702 in the filled binary image 730 can be analyzed, including the deflected droplets and the doublets, triplets, or quadruplets of droplets (generally the merged droplets) that have merged together. Generally, we want to distinguish single droplets (singlets) from the merged droplets in the droplet stream. The center of merged droplets may not properly represent a position along axes. The extracted center of single droplets (singlets) can more properly represent droplet position from which a more accurate center line for center droplets and deflection angle for deflected droplets can be measured.

In FIG. 9, a magnified droplet image 900 from the filled binary image 730 is shown in a bounding box. It is desirable to know the dimensions of the droplet to determine if it is a singlet or a merged droplet. An oval 902 is fitted to the overall structure of the droplet to extract features of width and height of the droplet. Droplets can be in many shapes but can generally be fit to an elliptical curve. Typically, there are cells or other particles within the droplets of sheathed sample fluid. A vertical axis 911 and a longitudinal axis 912 is fitted to the oval 902 at its maximum height and its maximum width. A center 913 or centroid of the droplet can be determined where the vertical axis 911 and the longitudinal axis 912 cross. The axes 911,912 can be further used to determine circularity and orientation of the droplet. The size of the oval 902 can be compared to known ranges of sizes for singlets and merged droplets so that a determination can be made if it is a singlet or one of the types of merged droplets. With the singlet droplets and the merged droplets identified in the filled binary image 730, machine learning algorithms can be used to further analyze the droplets and their position in the filled binary image 730 to determine if they are deflected droplets or center stream droplets.

Referring now back to FIG. 8, an unsupervised machine learning process 810U is performed on the detected droplets in the filled binary image 730 using an unsupervised machine learning algorithm. The unsupervised machine learning process 810U performs a clustering process 812 that clusters the detected droplets into groups of droplets that are along the center stream and droplets that are deflected off the center stream resulting in angled groups. The deflected droplets can be clustered together into groups that are angled to the left or to the right of the center stream. The unsupervised machine learning algorithm is a density-based clustering machine learning algorithm referred to as Density-Based Spatial Clustering of Applications with Noise (DBSCAN) algorithm. The unsupervised machine learning algorithm determines what desired deflected line each droplet belongs to. The DBSCAN algorithm finds the angle clusters (number of side streams and association of each droplet to a target deflection line).

For each deflected droplet in the filled binary image, a supervised machine learning process 810S is performed on the detected droplets in the filled binary image 730 using a supervised machine learning algorithm. The supervised machine learning process 810S performs a deflection angle error calculation 814 for each deflected droplet with respect to the desired line that it should fall along off of the center stream of droplets. The supervised machine learning algorithm computes the error for each droplet by comparing the distance between each droplet and the corresponding desired line previously detected by the unsupervised machine learning algorithm. The supervised ML algorithm finds the corresponding deflection error for each droplet with respect to the target line for that droplet (detected by unsupervised DBSCAN). The supervised ML algorithm is based on multiple nonlinear regression.

### Imaging and Strobe Light Generation

A camera and a strobe light are used synchronously together, signaled at appropriate times by a periodically generated strobe pulse, to capture brightfield still images. The cameras are high speed digital still cameras with a global shutter. The global shutter in each digital camera is activated over an exposure period to capture an image with a plurality of pixels sensors. The strobe light is pulsed one time during the exposure period to capture the image.

Referring now to FIG. 11A, a conventional strobe pattern, a strobe pulse train 1102 can be used in synchronous with a sign bit pulse train 1104 to periodically activate the LED strobe light. The sign bit pulse train 1104 can be associated with a zero-cross detection (or cross-over detection) of the piezo drive signal. The digital camera can be activated by a software timed trigger signal to capture an image over an exposure window time period 1106. The exposure time window period can have a time width between one hundred to two hundred milliseconds for example. The strobe pulse train 1102 typically has a plurality of pulses (e.g., 10 pulses) to activate the strobe light multiple times per exposure over a relatively lengthy exposure window 1106 for a plurality of zero-crossing detections being associated with the sign bit pulse train. The amplitude of the pulse signal in the strobe pulse train 1102 is the same at a constant level. Generally, a software timed trigger is used with the camera to hold the shutter or sample period of the camera for such a lengthy exposure period over the numerous strobes for each exposure period. That is, there are multiple strobes for one frame of image data (e.g., 1000:1 strobe-frame ratio) for multiple different cells to provide averaging. With the conventional strobe pattern, fuzzy droplet edges can appear in an image when there is a minor jitter in the strobe signal and/or cell flow. If there is any instability or disturbance in the sample fluid flow or the sheath fluid flow, the droplet stream can appear blurred with a conventional strobe pattern. Disturbances can occur due to numerous reasons such as sheath flow rate fluctuations, air bubbles passing through fluidic system, temperature variations, etc. Furthermore, the captured images of the droplet stream are sensitive to ambient light. The defection chamber is closed off from most ambient light by a pivotal door that covers over the deflection chamber, but for a small top opening and a bottom base slot. The small top opening allows the deflection chamber to receive drops along the center stream of droplets, and the bottom base slot allows deflected drops, and center drops to pass out of the deflection chamber.

Referring now to FIG. 11B, a new strobe pattern is used to further improve the image capture of a droplet stream for the cell sorter/flow cytometer. Instead of a software timed trigger, the hardware triggered cameras receive a hardware camera trigger signal 1110 to accurately trigger the digital cameras to begin image capture synchronous with or in time with a desired zero-cross detection sign-bit signal and the strobe light. The strobe pattern is a single LED strobe pulse 1112A,111B for one frame of image data captured over a short exposure window 1116, such as 200 microseconds, to capture an image of a number of droplets in the field of view of each digital camera. There can be a delay D between the LED strobe pulse 1112A for the first digital camera to capture jet breakoff and the LED strobe pulse 1112B for the second digital camera to capture droplet deflection due to a distance a droplet falls between each field of view. The delay D can be determined by knowing the flow/droplet velocity and the distance between a break off point at the top of field of view of the first camera and a first droplet at the top of field of view of the second camera. The strobe-to-frame ratio is 1:1 with the strobe pattern of the strobe pulse 1112A,1112B. No averaging is needed to analyze a single break-off of a droplet.

The objects (e.g., liquid jet, droplets, satellites) in the image have a high rate of velocity. The hardware trigger signal and the synched strobe pulses allow liquid jet breakoff to be regularly and periodically monitored with an inexpensive camera having a global shutter to capture all the pixels at the same time. Accordingly, each of the cameras are digital cameras with a global shutter responsive to a hardware trigger signal, such as the hardware camera trigger signal 1110. Without a global shutter, the captured image of droplets is distorted.

### Droplet Control System

A flow cytometer can generate up to a hundred thousand droplets every second for a frequency of 100 kHz. A high speed movie camera could capture droplet formation and jet breakoff if it had a speed that could generate one mega frames per second or ten mega frames per second. Instead of using an expensive super high speed video camera with a large amount of data in many frames to process, we can illuminate the droplet stream at certain points in time and capture a still image at those certain points in time. The image could be captured at certain phases in time, such as when a sinusoidal waveform of a known frequency crosses zero or crosses over another known constant value. That is, the hardware triggered camera can be synchronized in time with different phases of an alternating current (AC) signal that drives a piezo-electric device to vibrate. The period between phases can be associated with the droplet interval. Instead of seeing the whole process of a droplet develop with a movie captured by a high speed movie camera, you see the image of the droplet at the time when it breaks off from the jet stream. If the flow rate remains stable, at each zero-crossing (cross-over) of a sinusoidal waveform associated with the droplet interval, a still image of each droplet breaking off can be captured. The LED strobe light 211 and the first hardware triggered camera 212 as well as the LED array strobe light 308 and the second hardware triggered camera 350 can be synchronized with the zero-crossings (crossovers) to generate a strobe light signal and a shutter trigger signal to periodically (each droplet interval) capture images of the droplet stream at the breakoff point and during deflection in the deflection chamber. A sinusoidal waveform can be used as a driving signal to a piezo-electric device to vibrate the sheathed sample fluid. Other waveforms can also be used such as ramp, triangular, pulse, and square waveforms as long as they are periodical.

Using this driving signal to determine the zero-crossing (cross-over) points relates the image capture process to the droplet formation and the deflection of droplets.

The location of jet breakoff (jet breakoff point) from the stream and an interval between droplets (droplet interval or gap) are useful feedback in order to control the piezoelectric device and jet breakoff from the jet stream. For example, knowing a distance between the liquid jet stream up in the image and the first droplet can provide information regarding the stability of the jet breakoff point as well as the droplet rate generation. Stability of the jet breakoff point is important because the charge stream signal is synchronous with the breakoff of droplets. The charge algorithm for charging droplets uses spatial information to ensure that the droplet is stably charged immediately before the droplet breaks off from the liquid jet stream. The droplets as they break off can be variably charged to compensate for deflection errors and center error as they subsequently travel through the electrostatic field, thereby ensuring precise deflection and center line.

Referring now to FIG. 10 (FIGS. 10A-10B), a block diagram illustrates the structure and functional processes performed by a droplet control system 1000. The droplet control system 1000 is both a jet break off controller to control the formation of droplets and a droplet deflection controller to control the deflection of droplets for a sorting flow cytometer (cell sorter). At the center of the droplet control system is a synchronized controller 1002 that can be formed out of digital logic in an application specific integrated circuit (ASIC) or field programmable gate array (FPGA) control logic 1002A, and control instructions programmed by firmware/software/middleware into a microcontroller unit (MCU) 1002B, a digital signal processor (DSP), a single-board computer (SBC), and/or a general-purpose processor. The synchronized controller 1002 includes a finite state machine 1002C to control jet breakoff and droplet formation as shown in FIG. 10A, and a finite state machine 1002D to control droplet deflection and center stream positioning as shown in FIG. 10B. The controller further includes a field programmable gate array (FPGA) 1002A with control logic and a microcontroller 1002B with control instructions to selectively form either positive compensatory voltage values or negative compensatory voltage values. The first finite state machine 1002C and the second finite state machine 1002D control the functionality of the microcontroller 1002B. Overall, the controller 1002 controls the jet breakoff compensation and the deflection compensation for jet breakoff control and droplet deflection control.

If some sort of a disturbance occurs in the droplet stream causing a change to the jet breakoff point (location) from that selected by a user, the controller 1002 can automatically compensate and bring it back to the same jet breakoff point location based on visual feedback provided by the camera, dynamic modeling, image analysis, and closed loop control. A disturbance in the droplet stream can be caused by a minor clog in a hose or nozzle, some other glitches in some component (pump, valve) in the fluidics system that is not catastrophic, temperature fluctuations, or passing of air bubbles through the fluidic system in the vicinity of the flow cell. Additional details of the liquid jet breakoff control system are described in U.S. (U.S.) patent application Ser. No. 18/797,275 titled IMAGE CAPTURE AND AUTOMATED REGULATION FOR LIQUID JET BREAKOFF IN CELL SORTERS filed on Aug. 7, 2024, by inventor Mohammad N. Saadatzi, for all intents and purposes.

If an expected deflection angle of one or more droplets is in error, the controller 1002 can also automatically compensate the charge induced on the droplets in the droplet stream to drive the deflection error towards zero. If an expected center line of one or more droplets is in error, the synchronization controller 1002 can also automatically compensate the charge induced on the non-deflected droplets in the center stream to drive the error towards zero.

Generally, a droplet formation control process and a deflection control process starts with the frequency synthesizer or signal generator (waveform synthesizer) 1004 in generating a sinusoidal signal at a desired oscillation frequency for the piezo crystal that is used to form droplets. The sinusoidal signal is coupled into a zero-cross detection circuit 1016 to generate control signals and a variable gain amplifier 1006 to drive a piezo-electric crystal 1220 that can vibrate the sample injection tube (SIT) in the flow cell 1090. Before being coupled into the zero-cross detection circuit 1016 and the variable amplifier 1006, the analog sinusoidal signal from the signal generator 1004 with the desired frequency can be filtered by a bandpass Butterworth filter to remove noise and harmonics, if any, so that the signal does not form spurious zero-crossings (cross-overs). The bandpass Butterworth filter has a bandpass in a range of desired frequencies of the analog AC sinusoidal waveform signal to drive the piezo-electric device. The bandpass Butterworth filter has a pair of stop bands outside the bandpass range of desired frequencies to filter out harmonics thereof and any other noise sources.

A next process is to selectively amplify the amplitude of the sinusoidal signal with the variable gain amplifier 1004. The variable gain amplifier receives an AC waveform signal from the sinusoidal signal generator 1004 with a given input amplitude. It also receives a gain signal input from the controller 1002. The variable gain amplifier modifies the given input amplitude of the AC waveform signal based on a gain input signal to form a variable gain AC waveform signal that is coupled into the power amplifier 1008. The variable gain amplifier can be implemented by a multiplying digital to analog converter (MDAC). A lowpass Butterworth filter can be coupled to and between the variable gain amplifier 1006 and the high voltage power amplifier 1008. The low-pass Butterworth filter can smooth out the variable gain AC waveform signal before being coupled into the high voltage power amplifier by passing frequencies at a desired frequency and below.

The next process is to increase or further amplify 1008 the power levels in the sinusoidal signal with a power amplifier of constant gain so that it can drive the piezo-electric crystal 1220 in the flow cell 1090 with a desired amplitude and frequency.

In parallel, the zero-cross detector detects 1016 the times that the sinusoidal signal crosses over a constant voltage line, such as zero volts, and generate a narrow time pulse for each crossing. The zero crossing signals are coupled into the FGPA control logic 1002A of the controller 1002 so that synchronized strobe signals for the LED strobe lights and the hardware trigger or shutter signal for the hardware triggered cameras can be generated.

Based on the synchronized signals, the LED strobe light provides synchronized illumination 1024 for the droplet streams 1097,1098 of the flow cytometer/cell sorter. Based on the synchronized signals, the hardware triggered cameras capture synchronized images 1096,1095 of the droplet stream 1097,1098. The synchronized images 1096,1095 provide a form of visual feedback for the system. The synchronized images 1096,1095 of the droplet stream are coupled into the image processor for image processing 1050A,1050B. The image processor 1281 can be an FPGA, an ASIC, an MCU, or personal computer that is programmed to perform the image processing, the computer vision algorithms, a jet breakoff point algorithm, a droplet interval point algorithm, deflection angle error algorithm, and a center line error algorithm.

The image processor initially performs imaging processing steps 1050A,1050B on the synchronized raw images 1096,1095 of the droplet stream 1097,1098. The imaging processing steps 1050A,1050B include baseline removal, foreground segmentation (detecting a foreground and blanking out a background in the baseless image), and image binarization (See FIGS. 7A-7D and steps 801-806 in FIG. 8). The image processor then performs morphology analysis 1052 on the image of the droplet stream to extract features from the image. The image and extracted features are then input into a machine learning algorithm 1054A,1054B.

The image processor executes the machine learning algorithms 1054A,1054B.

Initially, a machine learning algorithm performs a clustering process on the droplet stream image that clusters the droplets together. One clustering algorithm is so satellites can be ignored in the droplet stream between droplets for jet breakoff controller. Another clustering algorithm is for clustering droplets in the deflection chamber into angle groups. The image processor executes a further machine learning algorithm with the clustered droplets. For jet break off control, the machine learning algorithm 1054A performs a first determination process that determines a measured breakoff point as a number of pixels from the top of the droplet stream image 1096.

The machine learning algorithm 1054A further preforms a second determination process that determines a measured droplet interval or gap as the number of pixels down from the measured breakoff point. The measured droplet interval (gap) point and the measured break off point from the image are coupled into the finite state machine 1002C executed by the controller 1002. The finite state machine 1002C generally includes two controllers to alternately generate a gain signal that is fed back into the variable amplification process and set the amplification of the analog sinusoidal signal. One unsupervised machine learning algorithm that can be used for clustering of droplets and satellites for jet breakoff control is a k-means clustering algorithm, but other unsupervised algorithms can be used, as well AI deep learning algorithms. The benefit of an unsupervised machine learning algorithm over a supervised one is that unsupervised is a label-free method and does not require training of the algorithm with labeled data. Training is a time consuming, and expensive stage of data analysis done in an offline fashion prior to the deployment of algorithms for real time analysis.

Generally, for droplet deflection control, a second finite state machine 1002D generates a digital gain signal to increase a charge on a droplet or decrease a charge on a droplet as it breaks off in order to adjust the deflection of deflected droplets and a center point of center droplets. The finite state machine 1002D has three states, a single deflected droplet control state 1063, a merged deflected droplet control state 1064, and a center stream control state 1065. The compensation by way of the digital gain signal differs for a merged deflected droplet from that of a single deflected droplet given the larger volume and surface area differences. The compensation by way of the digital gain signal for the center stream will differ from that of the deflected droplets in order to minimize error to the ideal center steam axis.

Based on the state of the microcontroller and the pulses from zero cross detection 1016, the FPGA control logic 1002A generates the digital gain signal in synchronous with the camera shutter trigger and the delayed strobe trigger for the synchronized sort camera 1026B and the delayed synchronized strobe light 1024B of the LED array strobe light. This enables capture of synchronized droplet deflection images 1095 of the droplet stream 1098 and the deflected droplets 1099 in the deflection chamber by the synchronized sort camera 1026B.

The synchronized droplet images 1095 captured by the synchronized sort camera 1026B are coupled to the image processor to undergo the image processing step 1050B (See also FIGS. 7A-7D, and steps 801-806 of FIG. 8). With each filled binary image from the image processing step 1050B, a morphological feature extraction and analysis step 1052B over the droplets in the filled binary image can occur (see also FIG. 9 and step 808 of FIG. 8). With extracted features acquired and morphological analysis of the droplets, machine learning algorithms 1054B can be performed on the images of the droplets to cluster droplets together, determine positions and angles of deflection for each droplet (see steps 810U,810S,812,814 in FIG. 8). The measured angles of deflection and droplet positions are coupled into the controller 1002 and processed by the state machine 1002D, microcontroller 1002B, and the FPGA control logic 1002A.

As soon as a main deflection situation occurs (like when a droplet is to be sorted to a sample tube, e.g., target line 1), the FPGA control logic 1002A charges the stream to an adequate value (such as a charge stream value ranging between −200 volts to 0 and 0 to +200 volts, e.g., −100 volts) by sending a digital value to the digital to analog (D/A) converter 1070. When a droplet breaks off from the main stream due to the piezo vibrations, the droplet that breaks off carries an electric charge linearly proportional to that value. A low voltage charge pulse train generator generates 1072 a pulse train with a frequency responsive to the analog output from the D/A converter 1070. A high speed high voltage amplifier 1074 substantially amplifies the amplitude of the pulse train into a high voltage pulse train that can be coupled to a carrier fluid conductive electrode 1076, via the sheath output port 219 or the sheath inlet port 218, in contact with the jet stream in the flow cell 1090.

After the droplet breaks off with the appropriate charge, the FPGA control logic 1002A generates the hardware trigger for the synchronized sort camera 1026B in order to open the camera aperture to get ready for image capture. It takes a predetermined time interval for the charged droplet to reach the field of view in of the synchronized sort camera 1026B. The predetermined time interval can be empirically calculated during characterization (initialization) of the center line and the deflected line. A timer in the FPGA logic counts down from the predetermined time interval (or counts up to the predetermined time interval) before generating a strobe trigger signal for the LED array to generate the delayed synchronized strobe light 1024B.

As soon as the timer goes off reaching the predetermined time interval, the FPGA control logic 1002A generates the strobe trigger signal with a narrow pulse (e.g., 500 ns or less) to trigger back illumination by the chip-on-board (COB) LED array to capture a frozen image of the deflected droplet.

The FPGA control logic 1002A then closes the camera aperture by disabling the camera trigger signal to capture a raw image of the charged droplet that is in front of the sort camera and deflected by the charged plates with a deflection angle proportional to the droplet charge. The captured image is coupled into the image processor for image processing. In one embodiment, the captured image is sent to a desktop computer via a serial cable (e.g., USB cable) for image processing by a desktop image processing and analysis application with a graphical user interface (GUI). In another embodiment, the cell sorter (sorting flow cytometer) has a built in image processor and analysis system to receive and process the raw deflection image.

The raw deflection image is read by the desktop image processing and analysis application (or the built in image processor and analyzer) to perform the image processing and morphology analysis, calculate a measured deflection angle, and determine a deflection angle error, if any, from the desired deflection angle. According to the deflection angle error, if any, the real-time controller 1002 modulates the charge signal to the carrier fluid electrode 1076 so that the following deflected droplets approach the reference deflection line with near zero deflection angle error.

The controller 1002 also implements a center line error calculation to compensate the charge on guard droplets that follow after a deflected droplet. The goal of center line error compensation is to keep the centerline as narrow as possible. From the images of the deflected droplets a measured centerline is determined and compared to the ideal centerline to determine a center line error. Based on the amount of center line error, the real-time controller 1002 modulates the charge signal on the carrier fluid electrode 1076 on a droplet-by-droplet basis so that the following guard droplets that break off approach the ideal center line with near zero center line error.

The voltage of each deflection plate are set to the same constant magnitude but with opposite polarity. The range of constant voltage may be from positive 100 volts to positive 6000 volts DC on one plate and negative 100 volts to negative 6000 volts DC on another plate. For example, a first charge plate is set to +3000V, and a second charge plate is set to −3000V to establish the electric field between the pair of angled charge plates. But in any case, the voltages on the pair of charge plates are not modulated during the sort process. The voltages are initialized to a certain value on each at the onset of the sort process and left unchanged during the sort process.

If a positive charge (e.g. positive 40 volts) is applied to a droplet, it is attracted to the second plate with the negative 3000 volts and its repelled by the first plate with the positive 3000 volts. Generally, a droplet charged to a positive voltage is attracted to and moves towards the negative charged plate and is repelled by and moves away from the positive charged plate. A droplet charged with a negative voltage, is attracted to and moves towards the positive charged plate and repelled and moves away from the negative charged plate.

The range of the stream charge signal applied to a droplet is between −200V to zero volts and zero volts to +200V, depending upon whether to deflect it to the left or to the right of the center stream. The charge compensation that is applied to correct for center error and deflection angle error is not a static value. It is a dynamically computed value based on the feedback of the errors obtained from the deflection images.

A deflection error is calculated for each droplet and the corresponding guard droplets (via all the machine learning algorithms). Subsequently, a dynamic charge compensation value is computed separately for each droplet angle group. The dynamic charge compensation value, a digital value, is output from the finite-state machine and the Proportional-Integral-Derivative (PID) controller 1002 and coupled into the digital to analog converter 1070 as shown in FIG. 10A. A change in the dynamic charge compensation value can rapidly, yet smoothly, attenuate the deflection angle error over a short period of time (a few frames of images) with minimal oscillatory behavior and zero steady-state error. For example, if an initial positive charge is applied to a droplet for a desired deflection angle, before breakoff, the charge can be increased by a positive compensatory voltage to increase the attraction and move the droplet towards a negative charged plate to compensate for deflection angle error found in an image. On the other hand, the initial positive charge can instead be decreased by a negative compensatory voltage to reduce the attraction and move the droplet back towards the center stream to compensate for an opposite deflection angle error found in an image.

The controller 1002 continues these processes after a frame delay. The frame delay is inserted so that the camera frame rate does not exceed a predetermined imaging rate value.

For example, the imaging rate can be set to ten frames per second so that the controller 1002 is not overburdened with performing calculations on too many frames or images of deflected droplets captured in the deflection chamber.

Generally, for jet breakoff control, a first finite state machine 1002C generates the gain signal (multiplier signal) that is coupled into the variable gain amplifier (multiplying DAC) to perform the selectively amplification process 1006 of the amplitude for the sinusoidal signal. The finite state machine 1002C has two states, a breakoff compensation state 1062 and a droplet interval compensation state 1060 that can use two independent controllers and control logic. The digital value of the gain signal determines the amount of amplification to apply to the sinusoidal signal to compensate for error between the measured and desired jet breakoff point for the breakoff compensation state 1062. By changing the vibration amplitude of the piezo-electric on the droplet stream, the gain signal can alter the jet breakoff point. The digital value of the gain signal also determines the amount of amplification to apply to the sinusoidal signal to compensate for error between the measured and desired drop interval (gap) point for the drop interval compensation state 1060. Changing the vibration amplitude of the piezo-electric crystal 1220 on the droplet stream, i.e., the gain signal, alters the droplet interval as well. The finite state machine 1002C switches states between the droplet interval compensation state 1060 and the breakoff compensation state 1062. Compensation of the breakoff point to maintain the desired, target, or selected jet breakoff point is prioritized over the compensation of the droplet interval when the actual or measured breakoff point is far away (more than one droplet distance) from the target or selected breakoff point set by the user.

As soon as the actual or measured breakoff point approaches the selected or target breakoff point and lies within one droplet distance, the finite state machine switches states to the droplet interval compensation state 1060 and the control system accordingly compensates gain of the variable gain amplifier to compensate for error in the droplet interval. This state is kept as active until the measured jet breakoff point moves outside the one-drop distance to the selected jet breakoff point, at which point the finite state machine switches back to breakoff control state.

During the breakoff compensation state 1062, the image processor compares the measured jet breakoff point determined from image of the droplet stream with the desired jet breakoff point input from a user interface to determine a difference or an error value in the break off point. The drop break off point error value is used to generate the digital gain signal and compensate for the difference or error value. For example, if the measured jet breakoff point is 400 pixels and the desired jet breakoff point is 280 pixels, the gain signal is increased to further amplify the sinusoidal signal and increase the vibrations in the sample tube so that drops break off earlier and closer to the top of the image 1096. As another example, if the measured jet breakoff point is 200 pixels and the desired jet breakoff point is 280 pixels, the gain signal is decreased to lower the amplification in the sinusoidal signal and decrease the vibrations in the sample tube so that droplets break off later and further away from the top of the image 1096.

During the droplet interval compensation state 1060, the image processor compares the measured droplet interval point determined from the image of the droplet stream with the desired droplet interval point input (selected droplet interval) from a user interface to determine a difference or an error value (droplet interval error) in the droplet interval. The droplet interval point error value is used to generate the digital gain signal and compensate for the difference or error value. For example, if the measured droplet interval is 10 pixels and the desired droplet interval point is 13 pixels down from the break off point, the gain signal is increased to further amplify the sinusoidal signal and increase the vibrations exerted on the sheathed sample liquid so that droplet interval is smaller. As another example, if the measured droplet interval point is 16 pixels and the desired droplet interval point is 13 pixels, the gain signal is decreased to lower the amplification in the sinusoidal signal and decrease the vibrations so that additional pixels are added to the droplet interval moving the first droplet further away from the breakoff point. Generally, over a range of values, the relationship between the amplitude of the sinusoidal signal and the droplet interval is linear. That is, the higher the amplitude of the sinusoidal signal the larger is the droplet interval.

Startup of the droplet control system to the desired frequency, jet breakoff point, and droplet interval is key. The desired frequency is set by a user/operator in the beginning along with the choice of nozzle and its orifice. The frequency synthesizer generates the frequency of the AC signal, which is held constant during the jet breakoff regulation process and the droplet interval regulation process, by the control system. During the jet breakoff regulation process and the droplet interval regulation process, the synchronized controller in the control system modulates the amplitude of the AC signal (associated with the gain of the MDAC) to vary the jet breakoff point and the droplet interval point.

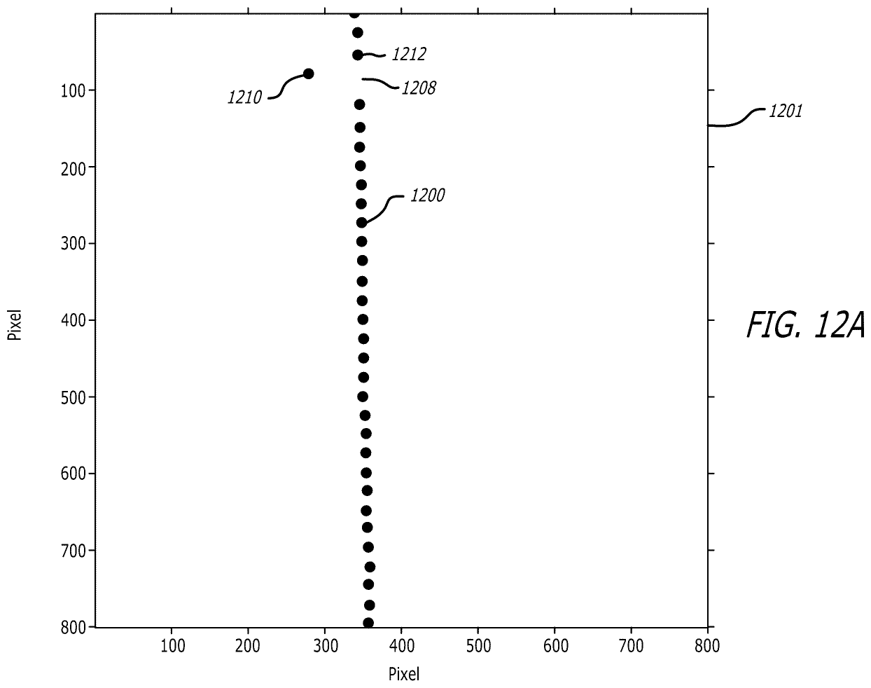

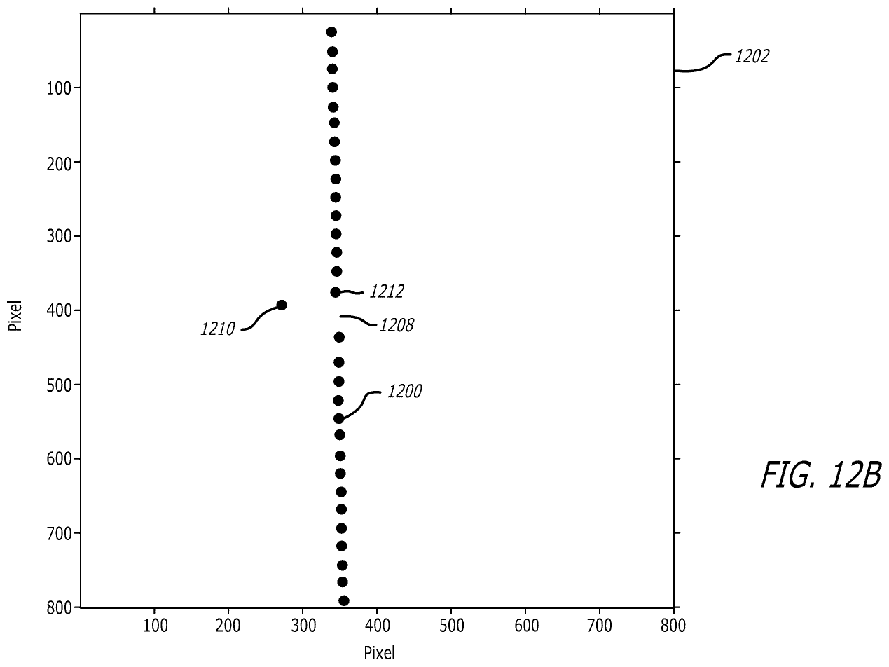

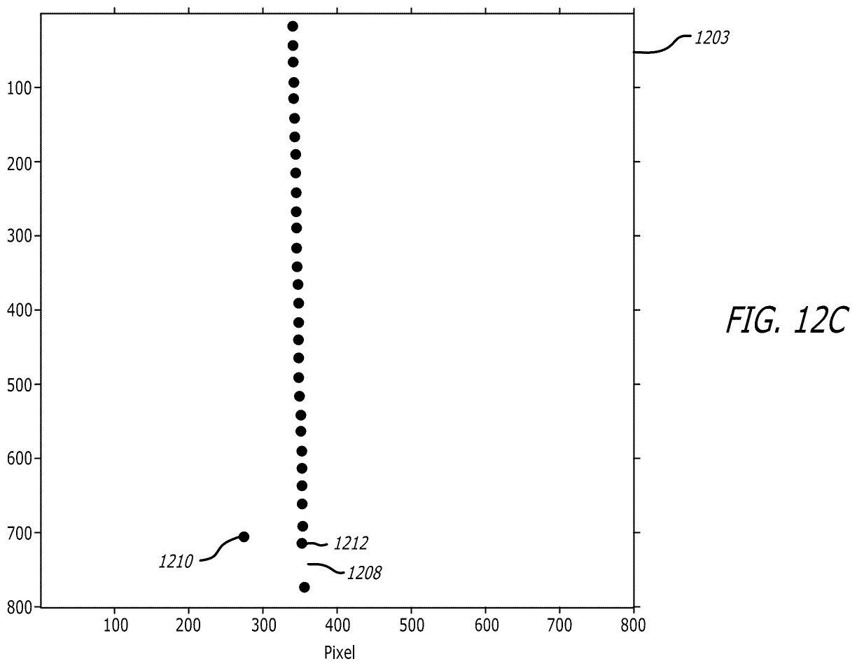

Referring now to FIGS. 12A-12C illustrating droplet deflection images 1201-1203 captured by a synchronized camera, a characterization (initialization) of the deflected droplets trajectory is now explained for the deflection controller 1002 and its deflection control algorithm to synchronize the illumination delay D in the strobe signal 1112B with the camera shutter trigger 1110 shown in FIG. 11B.

In a first step, the deflection control algorithm sets a drop illumination delay D of the strobe light to a number where a deflected droplet 1210, a merged droplet 1212, and a gap 1208 are all shown near a top of the first droplet deflection image 1201 shown in FIG. 12A. The deflected droplet 1210 is deflected away from the center droplet stream 1200.

Next in a second step, the deflection control algorithm detects a location of the deflected droplet 1210 in the droplet deflection image 1201. The droplet deflection images 1201-1203 are captured with an X pixel axis over a range of pixels such as zero to 800 pixels, and a Y pixel axis over a range of pixels such as zero to 800 pixels. The pixel coordinates for the position of the deflected droplet 1210 can be determine from projections to the X and Y axes.

For example, droplet 1210 in droplet deflection image 1201 is about 280 pixels, 80 pixels respectively in (X, Y) coordinates from an upper left hand corner at (0,0).

In a third step the deflection control algorithm saves the location coordinates of the droplet 1201 in the droplet deflection image associated with the drop illumination delay number that was set.

In a fourth step, the deflection control algorithm increases the drop illumination delay of the strobe light so that the deflected droplet 1210, merged droplet 1212, and gap 1208 are all seen in a lower location in a subsequent droplet deflection image 1202 of the center droplet stream 1200, such as shown in FIG. 12B. The controller and deflection control algorithm detects the location of the deflected droplet 1210 in the droplet deflection image 1202 and saves its location associated with the additional illumination delay number.

The controller and deflection control algorithm repeats first, second, and third steps numerous times so a final droplet deflection image 1203 of the deflected droplet 1210 is down near the bottom of the image, such as shown in FIG. 12C. On a next step of drop illumination delay for the strobe light, the droplet falls outside a next droplet image that is captured.

With a series of saved droplet coordinates of the deflected droplets collected in the prior steps, the controller 1002 and its deflection control algorithm performs a curve fitting (non-linear curve fitting due to the trajectory being of a second order) over the saved droplet coordinates in order to form a curve for a droplet path over the droplet deflection images 1201-1202 of deflected droplets.

The controller 1002 knows the different amount of strobe delay between the deflected droplet 1210 at the top of the droplet deflection image 1201 and the deflected droplet at the bottom of the droplet deflection image 1203. A half way value between the top of the image and the bottom of the image is used as the strobe delay in order to have margin on both sides in case there is disturbance in the flow velocity of the jet stream and the formation of droplets.

### Graphical User Interface

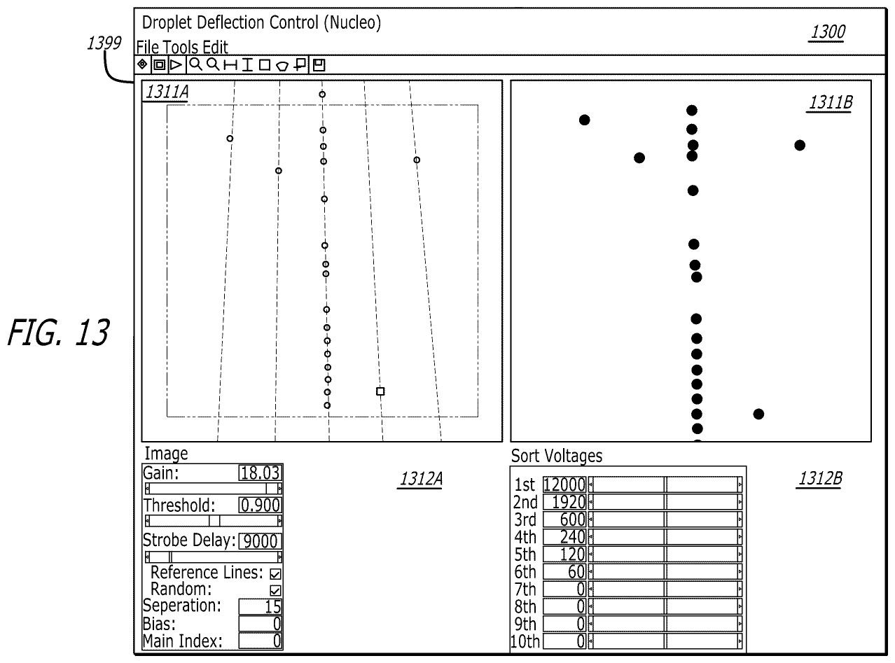

Referring now to FIG. 13, amongst other graphical user interfaces, a droplet deflection control graphical user interface (GUI) 1300 is generated by instructions executed by a processor (e.g., graphics processor) and displayed by a display device 1399 of a computer (e.g., computer 21 of FIG. 1) coupled to the cell sorter or a display device directly coupled the cell sorter. With the graphical user interface 1300, a user can set and control droplet deflection in the deflection chamber. The graphical user interface (GUI) is part of a desktop computer application that is designed to streamline the process of real time collection of captured deflection images.

The desktop application can also perform various image processing, signal processing, machine learning algorithms, finite-state machines, and control algorithms for deflection control as part of the controller 1002.

The graphical user interface (GUI) 1300 includes a plurality of droplet deflection image windows including a droplet deflection image window 1311A and a droplet deflection image window 1311B. The window 1311A displays a raw camera feed containing real-time frames transferred every 100 ms (for a frame rate of 10 FPS) from the camera via a USB 3.0 cable. A center reference line and multiple reference deflection lines are overlayed on the raw image in window 1311A to show the desired projectile trajectories for center droplets and deflected droplets. Each of the deflection lines corresponds to a certain collection tube in the collection chamber residing underneath the sort block. In window 1311A, there is an adjustable bounding box with adjustable sides over the raw image. The adjustable bounding box selects a portion of the raw imaged that is magnified portion the window 1311B.

Above the windows 1311A-1311B, in a toolbar section, there are menus and toolbar icons that allow connection to the hardware digital camera, electronics, and embedded firmware of the deflection controller. Under the windows 1311A-1311B, are one or more control input windows. Two user interface control panels 1312A-1312B are provided that a user can set for deflection control by the controller. Furthermore, a user can select open-loop manual deflection control or automated closed-loop deflection control for droplet deflection control.

In an image acquisition control input panel window 1312A, there are one or more control input windows (GUI widgets) by which the operator can set or input (i) a gain control of the camera (18.03, in this case); (ii) a threshold level of binarization for the image processing algorithm (0.900, in this case); (iii) a strobe delay which is the time interval in microseconds that takes the droplet to travel from the breakoff point to reach inside the sort block camera field of view (9000, in this case); (iv) the choice over illustration of the reference lines by a check box (enabled, in FIG. 13); (v) separation, which is the length of the droplet patterns that repeat over time (set to 15 in this case). The separation parameter is only relevant in the case of manual open loop drive of the charge signal. During closed-loop control, this parameter is irrelevant as the pattern is decided by the random arrival of cells in the stream; (vi) bias, which affects the center stream's overall angle (0, in this case); and (vii) main index, which is the index of the droplet of interest in the pattern (0th, in this case). The main index parameter is not relevant during closed-loop control.

In a sort voltage control input panel window 1312B, there are GUI widgets that set the desired voltage for each droplet in the desired pattern. The operator or user can set the charge values of the first droplet through to the 10th droplet via digital numbers or slide bars. These charge values are relevant during the open loop driving of the droplets. During automated closed-loop control, these charge values in the sort voltages panel 1312B are not used as the pattern and the corresponding voltage train is determined by the random arrival of cells in the stream.

### Advantages

There are a number of advantages to the disclosed embodiments. By capturing droplet deflection images in the deflection chamber, real time feedback and deflection control can be provided to improve sorting of droplets.

When implemented in software, the elements of the embodiments of the invention are essentially the code segments to perform the necessary tasks. The program or code segments can be stored in a processor readable medium to be read out by a processor for execution. The code segments can be downloaded into a processor readable medium via computer networks such as the Internet, Intranet, etc. Alternatively, the code segments can be transmitted from the processor readable medium by a computer data signal embodied in a carrier wave over a transmission medium or communication link to a processor for execution. The processor readable medium may include any medium that can store information. Examples of the processor readable storage medium include an electronic circuit, a semiconductor memory device, a random access memory (RAM), a read only memory (ROM), a flash memory, an erasable programmable read only memory (EPROM), a floppy diskette, a CD-ROM, an optical disk, a magnetic hard disk, etc.

This disclosure contemplates other embodiments or purposes. It will be appreciated that the embodiments of the invention can be practiced by other means than that of the described embodiments, which are presented in this description for purposes of illustration and not of limitation. The specification and drawings are not intended to limit the exclusionary scope of this patent document. It is noted that various equivalents for the particular embodiments discussed in this description may be practiced by the claimed invention as well. That is, while specific embodiments have been described, it is evident that many alternatives, modifications, permutations and variations will become apparent in light of the foregoing description. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, it is intended that the claimed invention embrace all such alternatives, modifications and variations as fall within the scope of the appended claims. The fact that a product, process, or method exhibits differences from one or more of the described exemplary embodiments does not mean that the product or process is outside the scope (literal scope and/or other legally recognized scope) of the following claims.

1-10. (canceled)

11. A flow cytometer or cell sorter system, the system comprising:
a fluidics system under pressure to cause a sheath fluid and a sample fluid with cells or particles to flow;
a flow cell assembly coupled in communication with the fluidics system to receive the sheath fluid and the sample fluid, the flow cell assembly including a flow cell body to surround the sample fluid with the sheath fluid to form a sheathed sample fluid, wherein the flow cell body has a base with a circular opening to allow a stream of the sheathed sample fluid to flow out into a nozzle and a cuvette to subsequently form a droplet stream along a fluid axis, the flow cell assembly further including a conductive electrode to receive and impart a variable electrical charge on the stream of the sheathed sample fluid to vary the electrical charge to the droplets in the droplet stream along the fluid axis;
a droplet deflection unit (DDU) to receive the droplet along the fluid axis, the droplet deflection unit including a back portion with a deflection chamber and a pivotal door pivotally coupled to the back portion to cover over the deflection chamber, the deflection chamber including a pair of charge plates through which the droplet stream falls along the fluid axis;
a first hardware triggered camera mounted to the back portion of the deflection chamber, the hardware triggered camera having a field of view to capture images of deflected droplets and centered droplets of the droplet stream along various fluid axes after passing through the pair of charge plates; and
a light emitting diode (LED) array strobe light mounted to the pivotal door on an opposite side of the first hardware triggered camera, the LED strobe array light pointed into the deflection chamber;
wherein an activation of the LED array strobe light generating a strobe light into the deflection chamber backlighting the droplet stream is synchronized with a triggering of the first hardware triggered camera to periodically capture a brightfield still image of a portion of the droplet stream along the various fluid axes below the pair of charge plates.

12. The system of claim 11, further comprising:
a center bracket coupled to the flow cell body of the flow cell assembly;
a flat mirror mounted to the center bracket below and in parallel with a backside of the flow cell body;
a second hardware triggered camera on one side of the flow cell body coupled to the center bracket, the hardware triggered camera pointed at the flat mirror on a first angle with a plane surface of the flat mirror; and
a diffused light emitting diode (LED) strobe light on an opposite side of the flow cell body coupled to the center bracket, the diffused LED strobe light pointed at the flat mirror on a second angle with the plane surface of the flat mirror;
wherein an activation of the diffused LED strobe light generates a diffused strobe light into the flat mirror backlighting the droplet stream that is synchronized with a triggering of the second hardware triggered camera to periodically capture a brightfield still image of a portion of the droplet stream along the fluid axis below the flow cell body.

13. The system of claim 12, wherein:
the synchronization of the activation of the diffused LED strobe light and the triggering of the second hardware triggered camera is in time with different phases of an alternating current (AC) signal that drives a piezo-electric device to vibrate and cause the sample fluid to form one or more droplets in the droplet stream.

14. The system of claim 12, wherein:
the flow cell further includes:
a cuvette below the base of the flow cell body, the cuvette having a flow channel to receive the stream of the sheathed sample fluid, and
a nozzle assembly below the cuvette, the nozzle assembly having a nozzle with an orifice to receive the stream of the sheathed sample fluid and form the droplet stream; and
the flat mirror is mounted to the center bracket such that it is below the cuvette and the nozzle assembly with the plane surface of the flat mirror parallel with the fluid axis of the droplet stream.

15. The system of claim 11, wherein:
the LED array strobe light includes:
a plurality of light emitting diodes all of which are coupled to a digital strobe signal to be activated and deactivated to form the strobe light, and
a printed circuit board coupled to the plurality of light emitting diodes, the printed circuit board having a connector to receive a first digital strobe signal and one or more metal traces to couple the first digital strobe signal to the plurality of light emitting diodes; and
the first hardware triggered camera includes:
a camera chip coupled to a first digital trigger signal, the camera chip having a plurality of camera pixels and a global shutter, the global shutter responsive to the first digital trigger signal to begin and end image capture by the plurality of camera pixels.

16. The system of claim 12, further comprising:
a first mounting bracket coupled to and between the second hardware triggered camera and the center bracket; and
a second mounting bracket coupled to and between the diffused LED strobe light and the center bracket.

17. The system of claim 16, wherein:
the diffused LED strobe light includes:
a plurality of infrared (IR) light emitting diodes all of which are coupled to a digital strobe signal to be activated and deactivated to form a strobe light, and an optical diffuser mounted in front of the plurality of light emitting diodes to form the diffused strobe light directed into the flat mirror; and
the second hardware triggered camera includes:
a camera chip coupled to a digital trigger signal, the camera chip having a plurality of camera pixels in an active area and a global shutter to capture pixel data concurrently in parallel with the plurality of camera pixels, the global shutter responsive to the digital trigger signal to begin and end image capture by the plurality of camera pixels.

18. The system of claim 17, wherein:
the diffused LED strobe light further includes:
a printed circuit board coupled to the plurality of light emitting diodes, the printed circuit board having a connector to receive the digital strobe signal and one or more metal traces to couple the digital signal to the plurality of light emitting diodes; and
a hollow housing with a hollow reflective chamber, the hollow housing having a first end to receive the optical diffuser and the printed circuit board, the hollow housing having a second end to couple to the second mounting bracket;
wherein the hollow reflective chamber reflects the diffused strobe light from the one end to the second end of the hollow housing and out toward the flat mirror.

19. The system of claim 17, wherein:
the second hardware triggered camera further includes:
a front enclosure coupled to the first mounting bracket, the front enclosure having an opening;
a printed circuit board coupled to the camera chip, the printed circuit board having a first connector to receive the digital trigger signal and one or more metal traces to couple the digital trigger signal to the camera chip, the printed circuit board having a second connector to couple to a processor to receive still images captured by the camera chip;
a camera body coupled to the printed circuit board;
one or more lenses coupled to the camera body and inserted through the opening of the front enclosure, the one or more lenses held in alignment over the camera chip to focus the droplet stream onto the active area of the camera chip; and
a back enclosure coupled to the camera body and the front enclosure to enclose the printed circuit board and couple the camera body to the first mounting bracket.

20. The system of claim 19, wherein:
the first mounting bracket includes an opening to receive a side scatter camera.

21. The system of claim 11, wherein the flow cell further includes:
a drop drive assembly including a sample injection tube (SIT), the sample injection tube coupled in communication with the fluidics system to receive the sample fluid;
a flow cell body around the drop drive assembly to receive the sample fluid from the sample injection tube, the flow cell body coupled in communication with the fluidics system to receive the sheath fluid, the flow cell body having a funnel portion to surround the sample fluid with the sheath fluid to form the sheathed sample fluid streaming out of an opening;
a cuvette coupled to a base of the flow cell body, the cuvette having a channel to receive the sheathed sample fluid streaming out of the opening, the cuvette being transparent to light and allowing the sheathed sample fluid to undergo interrogation in the channel by a plurality of different lasers to determine a plurality of different types of cells or particles therein; and
a nozzle assembly selectively engaged with the cuvette, the nozzle assembly having a nozzle and an O-ring around the nozzle selectively pressed against a face of the cuvette around the channel, the nozzle having an orifice to receive the sheathed sample fluid from the cuvette and form the droplet stream of the sheathed sample fluid out of the nozzle assembly.

22. The system of claim 12, wherein:
the flat mirror is behind the droplet stream along the fluid axis, and
the diffused strobe light is reflected off the flat mirror into the droplet stream towards the hardware triggered camera.

23. The system of claim 22, wherein:
an optical axis of the diffused LED strobe light intersects a vertical axis along the plane surface of the flat mirror at a first angle; and
the vertical axis along the plane surface of the flat mirror is offset from the fluid axis.

24. The system of claim 23, wherein:
an optical axis of the second hardware triggered camera intersects the vertical axis along the plane surface of the flat mirror at a second angle.

25. The system of claim 24, wherein:
the optical axis of the second hardware triggered camera intersects the fluid axis.

26. The system of claim 24, wherein:
the first angle and the second angle with the plane surface of the flat mirror are equivalent.

27. The system of claim 24, wherein:
the first angle and the second angle with the plane surface of the flat mirror are inequivalent.

28. The system of claim 17, wherein:
the optical diffuser is framed by a frame.

29. The system of claim 11, wherein:
the droplet stream along the fluid axis includes a jet stream and a plurality of droplets.

30. The system of claim 29, wherein:
the droplet stream along the fluid axis further includes one or more satellites.

31-58. (canceled)
